(19) United States
(12) Patent Application Publication
(10) Pub. No.: US 2021/0202982 A1
(43) Pub. Date: Jul. 1, 2021

(54) BOROHYDRIDE-SULFIDE INTERFACIAL LAYER IN ALL SOLID-STATE BATTERY

(71) Applicant: QUANTUMSCAPE CORPORATION, San Jose, CA (US)

(72) Inventors: Cheng-Chieh CHAO, San Jose, CA (US); Christopher DEKMEZIAN, Campbell, CA (US); Shuang LI, Sunnyvale, CA (US)

(21) Appl. No.: 16/755,855

(22) PCT Filed: Oct. 20, 2017
(86) PCT No.: PCT/US2017/057739

§ 371 Date: Apr. 13, 2020

(51) Int. Cl. H01M 10/0562; H01M 50/403; H01M 50/46; H01M 4/62; H01M 4/38

(52) U.S. Cl. CPC H01M 10/0562; H01M 50/403; H01M 2300/008; H01M 4/622; H01M 4/382; H01M 50/46

(57) ABSTRACT

Set forth herein are A(LiBH₄)(1−A)(P₂S₅) wherein 0.05<A≤0.95 compositions that are suitable for use as solid state bonding layer in lithium electrochemical devices. Also set forth herein are novel and inventive methods of making the A(LiBH₄)(1−A) (P₂S₅) compositions while utilizing scalable and commercial methods. Similarly, disclosed herein are novel electrochemical devices which incorporate these and other composite A(LiBH₄)(1−A)(P₂S₅) compositions or materials.

### FIELD

Provided herein is a solid-state composition comprising A(LiBH₄)(1−A)(P₂S₅), wherein 0.05≤A≤0.95, that is suitable as an electrolyte in a rechargeable battery having a lithium metal anode and/or as a low interfacial impedance bonding layer between a solid-state cathode and a solid-state electrolyte separator, such as a thin film or pellet of a lithium-stuffed garnet.

### BACKGROUND OF THE INVENTION

In a rechargeable Li⁺ ion battery, Li⁺ ions move from a negative electrode to a positive electrode during discharge and in the opposite direction during charge. This process produces electrical energy (Energy=Voltage×Current) in a circuit connecting the electrodes, which is electrically insulated from, but parallel to, the Li⁺ ion conduction path. The battery's voltage (V versus Li) is a function of the chemical potential difference for Li situated in the positive electrode as compared to the negative electrode and is maximized when Li metal is used as the negative electrode. An electrolyte physically separates and electrically insulates the positive and negative electrodes while also providing a conduction medium for Li⁺ ions. The electrolyte ensures that when Li metal oxidizes at the negative electrode during discharge (e.g., Li↔Li⁺+e⁻) and produces electrons, these electrons conduct between the electrodes by way of an external circuit which is not the same pathway taken by the Li⁺ ions.

Conventional rechargeable batteries use liquid electrolytes to conduct lithium ions between and within the positive and negative electrodes. However, liquid electrolytes suffer from several problems including flammability during thermal runaway, outgassing at high voltages, and chemical incompatibility with lithium metal negative electrodes. As an alternative, solid electrolytes have been proposed for next generation rechargeable batteries. For example, Li⁺ ion-conducting ceramic oxides, such as lithium-stuffed garnets, have been considered as electrolyte separators. See, for example, US Patent Application Publication No. 2015/0099190, published Apr. 9, 2015, and filed Oct. 7, 2014, titled GARNET MATERIALS FOR LI SECONDARY BATTERIES AND METHODS OF MAKING AND USING GARNET MATERIALS; U.S. Pat. Nos. 8,658,317; 8,092,941; and 7,901,658; also U.S. Patent Application Publication Nos. 2013/0085055; 2011/0281175; 2014/0093785; and 2014/0170504; also Bonderer, et al. “Free-Standing Ultrathin Ceramic Foils,” Journal of the American Ceramic Society, 2010, 93, 3624-3631; and Murugan, et al., Angew Chem. Int. Ed. 2007, 46, 7778-7781), the entire contents of each of these publications are incorporated by reference in their entirety for all purposes. See also, e.g., Maekawa, H. et al., Journal of the American Chemical Society 2009, 131, 894-895; Matsu, M. et al., Chem. Mater. 2010, 22, 2702-2704; Zhou, Y. et al. Materials Transactions 2011, 52, 654; and Borgschulte. A. et al., Energy Environ. Sci. 2012, 5, 6823-6832), the entire contents of each of these publications are incorporated by reference in their entirety for all purposes.

Solid electrolytes tend to reduce a battery's total weight and volume, when compared to a liquid electrolyte, and thereby increase its gravimetric and volumetric energy density. Despite these advantages, solid electrolytes are still insufficient in several regards for commercial applications. Notably, solid electrolytes tend to include defects, grain boundaries, pores, atomic vacancies, uneven or rough surfaces, and other inhomogeneous, non-uniform features which researchers find correlate with the formation of Li-dendrites when these electrolytes are used in electrochemical cells. A challenge in the field has been to modify and/or reduce the number of these defects.

Another challenge in the relevant field has been to make an all solid-state battery having low interfacial impedances between the battery's solid-state components. Prior approaches to achieving low interfacial impedances between the battery's solid-state components including merely applying pressure, such as 10,000 pounds-per-square-inch (PSI), to a stack of solid-state battery components. However, low interfacial impedances were still not achieved. See for example, Unemoto, et al. “Fast lithium-ionic conduction in a new complex hydride-sulphide crystalline phase,” Royal Society of Chemistry; 2016, 52, 564-566. As such, it remains a challenge to mate, for example, certain solid-state electrolyte separators and certain solid-state cathodes in a commercially viable and scalable manner with low interfacial impedance between the solid-state electrolyte separators and the solid-state cathodes.

What is needed are, for example, new separators, e.g., a thin-film composite of a lithium-stuffed garnet with a material which passivates sites on the lithium-stuffed garnet from forming lithium dendrites. The instant disclosure provides solutions to some of these problems as well as others problems in the relevant field.

### SUMMARY

Disclosed herein are compositions comprising A(LiBH₄)(1−A)(P₂S₅), wherein 0.05≤A≤0.95 (herein “LBHPS”), as a bonding layer between a solid-state electrolyte separator and a solid-state cathode, as well as methods for making and using such compositions to prepare a thin film solid electrolyte for a solid-state lithium-secondary battery, and optionally wherein the thin film solid electrolyte is a bonding layer between an oxide solid-state electrolyte separator, e.g., lithium-stuffed garnet, and a solid-state positive electrode.

In one embodiment, set forth herein is a composition comprising A(LiBH₄)(1−A)(P₂S₅), wherein 0.05≤A≤0.95.

In a second embodiment, disclosed herein is a method of making the composition A(LiBH₄)(1−A)(P₂S₅) wherein 0.05≤A≤0.95.

In a third embodiment, set forth herein is an electrochemical cell that includes a lithium metal negative electrode; a solid separator; and a positive electrode, wherein the solid separator is between and in direct contact with the lithium metal negative electrode and the positive electrode; and wherein the solid separator includes a composition comprising A(LiBH₄)(1−A)(P₂S₅), wherein 0.05≤A≤0.95.

In a fourth embodiment, set forth herein is a method for making a thin film that includes A(LiBH₄)(1−A)(P₂S₅), wherein 0.05≤A≤0.95, wherein the methods includes the following steps: (a) providing a powder mixture, wherein the powder mixture includes A(LiBH₄)(1−A)(P₂S₅), wherein 0.05≤A≤0.95; (b) milling the powder mixture; (c) mixing the powder mixture with a solvent or a binder or with both a solvent and a binder; (d) casting or coating the powder mixture on a substrate; (e) spinning the substrate at 3000 rotations per minute (rpm) to form a thin film; (f) evaporating the solvent, if present; and (g) placing the film and the substrate under pressure.

In a fifth embodiment, set forth herein is an electrochemical device that includes a lithium metal negative electrode; a solid-state electrolyte; a solid-state positive electrode; and a composition comprising A(LiBH₄)(1−A)(P₂S₅), wherein 0.05≤A≤0.95 or a thin film made by a method herein; wherein the solid-state electrolyte is between and in contact with the lithium metal negative electrode and the solid-state positive electrode; and the composition comprising A(LiBH₄)(1−A)(P₂S₅), wherein 0.05≤A≤0.95, or the thin film made by a method herein, is between and in contact with the solid-state electrolyte and the solid-state positive electrode.

In a sixth embodiment, set forth herein is a composite material that includes both lithium-stuffed garnet and a composition comprising A(LiBH₄)(1−A)(P₂S₅)).

In a seventh embodiment, set forth herein is a method for coating a lithium-ion conducting separator electrolyte, the method comprising a) providing the lithium-ion conducting separator electrolyte; and b) pressing a composition of A(LiBH₄)(1−A)(P₂S₅), wherein 0.05≤A≤0.95, on to at least one surface of the lithium-ion conducting separator electrolyte; wherein the pressing is at a temperature between 100-280° C. and at a pressure of 10-2000 PSI.

In a eighth embodiment, set forth herein is a method for coating a lithium-ion conducting electrolyte separator, the method including the steps: (a) providing a lithium-ion conducting electrolyte separator; (b) providing a mixture of a solvent and a composition A(LiBH₄)(1−A)(P₂S₅), wherein 0.05≤A≤0.95; and (c) depositing the mixture on the electrolyte separator by spray coating, melt spin coating, spin coating, dip coating, slot die coating, gravure coating, or microgravure coating.

### BRIEF DESCRIPTION OF THE DRAWING

FIG. 1 shows an X-ray diffraction pattern of LBHPS powder after heat treatment at 150° C. for 2 hours, as described in Example 1.

FIG. 2 shows an Arrhenius plot of log(Conductivity (S/cm)) versus reciprocal temperature (1000/T) (Kelvin) for a two LBHPS samples pressed at 100 kPSI at 30° C., 45° C., 80° C., and 100° C. The data was acquired using VSP-300. The LBHPS was 0.9(LiBH₄)0.1(P₂S₅) as a 12.7 mm diameter pellet that is 0.8 mm thick. The pellet was sandwiched between steel plungers and EIS performed at the temperature shown in FIG. 2, at frequency 1 MHz to 1 Hz.

FIG. 3 shows an optical image of a LBHPS thin film double casted onto a solid-state sulfide cathode, as described in Example 6.

FIG. 4 shows densified LBHPS film on top of a solid-state cathode and then punched into an 8 mm disk to be used in testing.

FIG. 5 shows an illustration of a full cell, according to Example 8, architecture containing an LBHPS bonding layer between the solid-state separator and a solid-state cathode. In the figure, 10 the solid-state cathode (80 wt % NCA, 18 wt % LSTPS, 1.5 wt % binder), 20, contacts the bonding layer LBHPS (not illustrated), which is between an lithium-stuffed garnet (Li₇La₃Zr₂O₁₂Al₂O₃) separator film, 30, and a lithium metal anode, 40.

FIG. 6 shows a focused-ion beam scanning electron microscopy (FIB-SEM) image of a cross-section of an LBHPS bonding layer calendered on top of the solid-state cathode. In the figure, 50 is the solid-state sulfide cathode; 60 is densified LBHPS bonding layer; 70 is the sample mounting carbon tape.

FIG. 7 shows the the discharge capacity retention and median discharge ASR of a full cell containing LBHPS bonding layer in the first three cycles at C/10 rate.

FIG. 8. is a Galvanostatic intermittent titration plot.

FIG. 9 shows one embodiment of an energy storage device 910 including a cathode 920, a solid-state ion conductor 930, an anode 940, and current collectors 950 and 960.

FIG. 10A shows one embodiment of an energy storage device 1010 including a cathode 1020, a solid-state ion conductor 1030 which includes a lithium-stuffed garnet 1030A and a LBHI layer 1030B, an anode 1040, current collectors 1050 and 1060, and a cathode-facing separator 1070.

FIG. 10B shows another embodiment of an energy storage device 1010 including a cathode 1020, a solid-state ion conductor 1030 which includes a lithium-stuffed garnet 1030A and a LBHI layer 1030B, an anode 1040, current collectors 1050 and 1060, and a catholyte 1070 infiltrated within cathode 1020.

FIG. 11 shows another embodiment of an energy storage device 1110 including a cathode 1120, a solid-state ion conductor 1130 which includes a lithium-stuffed garnet 1130A and a LBHI layer 1130B, an anode 1140, current collectors 1150 and 1160, and a cathode-facing separator 1170.

### DETAILED DESCRIPTION OF THE INVENTION

The following description is presented to enable one of ordinary skill in the art to make and use the inventions set forth herein and to incorporate these inventions in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

Furthermore, any element in a claim that does not explicitly state “means for” performing a specified function, or “step for” performing a specific function, is not to be interpreted as a “means” or “step” clause as specified in pre-America Invents Act (AIA) 35 U.S.C. Section 112, Paragraph 6 or post-AIA 35 U.S.C. Section 112(f). In particular, the use of “step of” or “act of” in the Claims herein is not intended to invoke the provisions of pre-AIA 35 U.S.C. Section 112, Paragraph 6 or post-MA 35 U.S.C. Section 112(f).

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### General

In one embodiment, disclosed herein is a method for making a thin film including the A(LiBH₄)(1−A)(P₂S₅) composition, the method including a) providing a LBHPS powder, b) making a slurry using solvents and binders, c) casting the slurry onto a solid state cathode, d) optionally compressing or calendering the solid state electrolyte and the solid state cathode, and e) punching or cutting electrodes to place into a full cell. In another embodiment, disclosed herein is a method for making a thin film including the A(LiBH₄)(1−A)(P₂S₅) composition, the method including a) providing a LBHPS powder, b) making a slurry using solvents and binders, c) casting the slurry onto a solid state separator to form a bilayer, d) optionally compressing or calendering the bilayer, and e) laminating or stacking the bilayer onto a solid state cathode to form a full cell. In another embodiment, also disclosed herein are electrochemical devices which incorporate these materials. For example, disclosed herein is an electrochemical cell having a lithium metal negative electrode; a solid separator; and a positive electrode with a bonding layer of LBHPS between the solid state separator and the positive cathode.

### Definitions

If a definition provided in any material incorporated by reference herein conflicts with a definition provided herein, the definition provided herein controls.

As used herein, the phrase “solid-state cathode” or “solid-state positive electrode” refers to a type of “positive electrode” defined herein. All components in this solid-state cathode film are in solid form. The solid-state cathode includes active cathode materials as defined herein; solid-state catholyte as defined herein, optionally a conductive additive, and optionally binders. In some examples, the solid-state cathode is a densified film.

As used herein, the phrase “current collector” refers to a component or layer in a secondary battery through which electrons conduct, to or from an electrode in order to complete an external circuit, and which are in direct contact with the electrode to or from which the electrons conduct. In some examples, the current collector is a metal (e.g., Al, Cu, or Ni, steel, alloys thereof, or combinations thereof) layer which is laminated to a positive or negative electrode. In some examples, the current collector is Al. In some examples, the current collector is Cu. In some examples, the current collector is Ni. In some examples, the current collector is steel. In some examples, the current collector is an alloy of Al. In some examples, the current collector is an alloy of Cu. In some examples, the current collector is an alloy of steel. In some examples, the current collector is Al. In some examples, the current collector comprises a combination of the above metals. During charging and discharging, electrons move in the opposite direction to the flow of Li ions and pass through the current collector when entering or exiting an electrode.

As used herein, the phrase “at least one member selected from the group,” includes a single member from the group, more than one member from the group, or a combination of members from the group. At least one member selected from the group consisting of A, B, and C includes, for example, A, only, B, only, or C, only, as well as A and B as well as A and C as well as B and C as well as A, B, and C or any other all combinations of A, B, and C.

As used herein, the phrase “slot casting,” or “slot die coating” refers to a deposition process whereby a substrate is coated, or deposited, with a solution, liquid, slurry, or the like by flowing the solution, liquid, slurry, or the like, through a slot or mold of fixed dimensions that is placed adjacent to, in contact with, or onto the substrate onto which the deposition or coating occurs. In some examples, slot casting includes a slot opening of about 1 to 100 μm.

As used herein, the phrase “dip casting” or “dip coating” refers to a deposition process whereby a substrate is coated, or deposited, with a solution, liquid, slurry, or the like, by moving the substrate into and out of the solution, liquid, slurry, or the like, often in a vertical fashion, sometimes at an angle, such as 45° from the surface of the solution, liquid slurry, or the like.

As used herein, the phrase “solid-state catholyte,” or the term “catholyte” refers to an ion conductor that is intimately mixed with, or surrounded by, a cathode (i.e., positive electrode) active material (e.g., a metal fluoride optionally including lithium).

As used herein, the term “electrolyte,” refers to a material that allows ions, e.g., Li⁺, to migrate therethrough, but which does not allow electrons to conduct therethrough. Electrolytes are useful for electrically insulating the cathode and anode of a secondary battery while allowing ions, e.g., Li⁺, to transmit through the electrolyte. Solid electrolytes, in particular, rely on ion hopping and/or diffusion through rigid structures. Solid electrolytes may be also referred to as fast ion conductors or super-ionic conductors. In this case, a solid electrolyte layer may be also referred to as a solid electrolyte separator.

As used herein, the term “anolyte,” refers to an ionically conductive material that is mixed with, or layered upon, or laminated to, an anode material or anode current collector.

As used herein the term “making,” refers to the process or method of forming or causing to form the object that is made. For example, making an energy storage electrode includes the process, process steps, or method of causing the electrode of an energy storage device to be formed. The end result of the steps constituting the making of the energy storage electrode is the production of a material that is functional as an electrode.

As used herein the phrase “energy storage electrode,” refers to, for example, an electrode that is suitable for use in an energy storage device, e.g., a lithium rechargeable battery or Li-secondary battery. As used herein, such an electrode is capable of conducting electrons and Li ions as necessary for the charging and discharging of a rechargeable battery.

As used herein, the phrase “providing” refers to the provision of, generation or, presentation of, or delivery of that which is provided.

As used herein, the phrase “lithium-stuffed garnet” refers to oxides that are characterized by a crystal structure related to a garnet crystal structure. Examples of lithium-stuffed garnets are set forth in U.S. Patent Application Publication No. 2015/0099190, which published Apr. 9, 2015, and was filed Oct. 7, 2014 as Ser. No. 14/509,029, and is incorporated by reference herein in its entirety for all purposes. This application describes Li-stuffed garnet solid-state electrolytes used in solid-state lithium rechargeable batteries. These Li-stuffed garnets generally having a composition according to Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E<3, 10<F<13, and M′ and M″ are each, independently in each instance selected from Ga, Al, Mo, W, Nb, Sb, Ca, Ba, Sr, Ce, Hf, Rb, and Ta, or LiₐLa_{b}Zr_{c}Al_{d}Me″ₑO_{f}, wherein 5<a<8.5; 2<b<4; 0<c≤2.5; 0≤d<2; 0≤e<2, and 10<f<13 and Me″ is a metal selected from Ga, Nb, Ta, V, W, Mo, and Sb and as otherwise described in U.S. Patent Application Publication No. 2015/0099190. As used herein, lithium-stuffed garnets, and garnets, generally, include, but are not limited to, Li_{7.0±δ}La₃(Zrₜ₁+Nbₜ₂+Taₜ₃)O₁₂+0.35Al₂O₃; wherein δ is from 0 to 3 and (t1+t2+t3=2) so that the La:(Zr/Nb/Ta) ratio is 3:2. For example, δ is 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0. In some examples, the Li-stuffed garnet herein has a composition of Li_{7±δ}Li₃Zr₂O₁₂.xAl₂O₃. In yet another embodiment, the Li-stuffed garnet herein has a composition of Li_{7±δ}Li₃Zr₂O₁₂.0.22Al₂O₃. In yet other examples, the Li-stuffed garnet herein has a composition of Li_{7±δ}Li₃Zr₂O₁₂.0.35Al₂O₃. In certain other examples, the Li-stuffed garnet herein has a composition of Li_{7±δ}Li₃Zr₂O₁₂.0.5Al₂O₃. In another example, the Li-stuffed garnet herein has a composition of Li_{7±δ}Li₃Zr₂O₁₂.0.75Al₂O₃. Also, L-stuffed garnets used herein include, but are not limited to, LiₓLa₃Zr₂O_{F}+yAl₂O₃, wherein x ranges from 5.5 to 9; and y ranges from 0.05 to 1. In these examples, subscripts x, y, and F are selected so that the Li-stuffed garnet is charge neutral. In some examples x is 7 and y is 1.0. In some examples, x is 5 and y is 1.0. In some examples, x is 6 and y is 1.0. In some examples, x is 8 and y is 1.0. In some examples, x is 9 and y is 1.0. In some examples x is 7 and y is 0.35. In some examples, x is 5 and y is 0.35. In some examples, x is 6 and y is 0.35. In some examples, x is 8 and y is 0.35. In some examples, x is 9 and y is 0.35. In some examples x is 7 and y is 0.7. In some examples, x is 5 and y is 0.7. In some examples, x is 6 and y is 0.7. In some examples, x is 8 and y is 0.7. In some examples, x is 9 and y is 0.7. In some examples x is 7 and y is 0.75. In some examples, x is 5 and y is 0.75. In some examples, x is 6 and y is 0.75. In some examples, x is 8 and y is 0.75. In some examples, x is 9 and y is 0.75. In some examples x is 7 and y is 0.8. In some examples, x is 5 and y is 0.8. In some examples, x is 6 and y is 0.8. In some examples, x is 8 and y is 0.8. In some examples, x is 9 and y is 0.8. In some examples x is 7 and y is 0.5. In some examples, x is 5 and y is 0.5. In some examples, x is 6 and y is 0.5. In some examples, x is 8 and y is 0.5. In some examples, x is 9 and y is 0.5. In some examples x is 7 and y is 0.4. In some examples, x is 5 and y is 0.4. In some examples, x is 6 and y is 0.4. In some examples, x is 8 and y is 0.4. In some examples, x is 9 and y is 0.4. In some examples x is 7 and y is 0.3. In some examples, x is 5 and y is 0.3. In some examples, x is 6 and y is 0.3. In some examples, x is 8 and y is 0.3. In some examples, x is 9 and y is 0.3. In some examples x is 7 and y is 0.22. In some examples, x is 5 and y is 0.22. In some examples, x is 6 and y is 0.22. In some examples, x is 8 and y is 0.22. In some examples, x is 9 and y is 0.22. Also, Li-stuffed garnets as used herein include, but are not limited to, LiₓLa₃Zr₂O₁₂+yAl₂O₃, wherein y is from 0 to 1 and includes 0 and 1. In one embodiment, the Li-stuffed garnet herein has a composition of Li₇Li₃Zr₂O₁₂.

As used herein, garnet or Li-stuffed garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the phrases “garnet precursor chemicals,” “chemical precursor to a garnet-type electrolyte,” “precursors to garnet” and “garnet precursor materials” refer to chemicals which react to form a lithium stuffed garnet material described herein. These chemical precursors include, but are not limited to lithium hydroxide (e.g., LiOH), lithium oxide (e.g., Li₂O), lithium carbonate (e.g., LiCO₃), zirconium oxide (e.g., ZrO₂), lanthanum oxide (e.g., La₂O₃), lanthanum hydroxide (e.g., La(OH)₃), aluminum oxide (e.g., Al₂O₃), aluminum hydroxide (e.g., Al(OH)₃), AlOOH, aluminum (e.g., Al), Boehmite, gibbsite, corundum, aluminum nitrate (e.g., Al(NO₃)₃), aluminum nitrate nonahydrate, niobium oxide (e.g., Nb₂O₅), gallium oxide (Ga₂O₃), and tantalum oxide (e.g., Ta₂O₅). Other precursors to garnet materials, known in the relevant field to which the instant disclosure relates, may be suitable for use with the methods set forth herein.

As used herein the phrase “garnet-type electrolyte,” refers to an electrolyte that includes a lithium-stuffed garnet material described herein as a Li′ ion conductor. The advantages of Li-stuffed garnet solid-state electrolytes are many, including as a substitution for liquid, flammable electrolytes commonly used in lithium rechargeable batteries.

As used herein, the phrase “doped with alumina” means that Al₂O₃ is used to replace certain components of another material, e.g., a garnet. A lithium stuffed garnet that is doped with Al₂O₃ refers to garnet wherein aluminum (Al) substitutes for an element in the lithium stuffed garnet chemical formula, which may be, for example, Li or Zr.

As used herein, the phrase “subscripts and molar coefficients in the empirical formulas are based on the quantities of raw materials initially batched to make the described examples” means the subscripts, (e.g., 7, 3, 2, 12 in Li₇La₃Zr₂O₁₂ and the coefficient 0.35 in 0.35Al₂O₃) refer to the respective elemental ratios in the chemical precursors (e.g., LiOH, La₂O₃, ZrO₂, Al₂O₃) used to prepare a given material, (e.g., Li₇La₃Zr₂O₁₂.0.35Al₂O₃), unless specified otherwise.

As used herein, the phrase “electrochemical device” refers to an energy storage device, such as, but not limited to a Li-secondary battery that operates or produces electricity or an electrical current by an electrochemical reaction, e.g., a conversion chemistry reaction such as 3Li+FeF₃↔3LiF+Fe.

As used herein, the phrase “film thickness” refers to the distance, or median measured distance, between the top and bottom faces of a film. As used herein, the top and bottom faces refer to the sides of the film having the largest surface area.

As used herein, the term “grains” refers to domains of material within the bulk of a material that have a physical boundary which distinguishes the grain from the rest of the material. For example, in some materials both crystalline and amorphous components of a material, often having the same chemical composition, are distinguished from each other by the boundary between the crystalline component and the amorphous component, or a boundary between regions of different crystalline orientation. The approximate diameter of the region between boundaries of a crystalline component, or of an amorphous component, is referred herein as the grain size. Grains may be observed in SEM if appropriate techniques are applied to bring the grains into higher relief; these techniques may include chemical etching or exposure to high energy electron beams.

As used herein, the term “diameter (d₉₀)” refers to the size, in a distribution of sizes, measured by microscopy techniques or other particle size analysis techniques, including, but not limited to, scanning electron microscopy or dynamic light scattering. D₉₀ includes the characteristic dimension at which 90% of the particles are smaller than the recited size. Similarly, the term “diameter (d₅₀)” includes the characteristic dimension at which 50% of the particles are smaller than the recited size. Similarly, the term “diameter (d₁₀)” includes the characteristic dimension at which 10% of the particles are smaller than the recited size. These figures may be calculated on a per-volume or per-number basis.

As used herein the phrase “active anode material” refers to an anode material that is suitable for use in a Li rechargeable battery that includes an active cathode material as defined above. In some examples, the active material is Lithium metal.

As used herein the phrase “casting a film,” refers to the process of delivering or transferring a liquid or a slurry into a mold, or onto a substrate, such that the liquid or the slurry forms, or is formed into, a film. Casting may be done via doctor blade, meyer rod, comma coater, gravure coater, microgravure, reverse comma coater, slot dye, slip and/or tape casting, and other methods known to those skilled in the art.

As used herein the phrase “applying a pressure,” refers to a process whereby an external device, e.g., a calendar, induces a pressure in another material.

As used herein the phrase “average pore diameter dimensions of about 5 nm to about 1 μm” refers to a material that has pores wherein the inner diameter of the pores therein are physically spaced by about 5 nm, for nanopores for example, to about 1 μm, for micropores for example.

As used herein the term “infiltrated,” refers to the state wherein one material passes into another material, or when one material is caused to join another material. For example, if a porous Garnet is infiltrated with LBHI, this refers to the process whereby LBHI is caused to pass into and intimately mix with the porous Garnet.

As used herein, the terms “separator,” and “Lit ion-conducting separator,” are used interchangeably with separator being a short-hand reference for Li′ ion-conducting separator, unless specified otherwise explicitly. A separator refers to a solid electrolyte which conducts Li⁺ ions, is substantially insulating to electrons, and which is suitable for use as a physical barrier or spacer between the positive and negative electrodes in an electrochemical cell or a rechargeable battery. A separator, as used herein, is substantially insulating when the separator's lithium ion conductivity is at least 10³, and typically 10⁶ times, greater than the separator's electron conductivity. A separator can be a film, monolith, or pellet. Unless explicitly specified to the contrary, a separator as used herein is stable when in contact with lithium metal.

As used here, the phrase “inorganic solid-state electrolyte,” is used interchangeably with the phrase “solid separator” refers to a material which does not include carbon and which conducts atomic ions (e.g., Lit) but does not conduct electrons. An inorganic solid state electrolyte is a solid material suitable for electrically isolating the positive and negative electrodes of a lithium secondary battery while also providing a conduction pathway for lithium ions. Example inorganic solid-state electrolytes include oxide electrolytes and sulfide electrolytes, which are further defined below. Non-limiting example sulfide electrolytes are found, for example, in U.S. Pat. No. 9,172,114, which issued Oct. 27, 2015, and also in US Patent Application Publication No. 2017-0162901 A1, which published Jun. 8, 2017, and was filed as U.S. patent application Ser. No. 15/367,103 on Dec. 1, 2016, the entire contents of which are herein incorporated by reference in its entirety for all purposes. Non-limiting example oxide electrolytes are found, for example, in US Patent Application Publication No. 2015-0200420 A1, which published Jul. 16, 2015, the entire contents of which are herein incorporated by reference in its entirety for all purposes. In some examples, the inorganic solid-state electrolyte also includes a polymer.

As used herein, the phrase “lithium interfacial resistance,” refers to the interfacial resistance of a material towards the incorporation of Li⁺ ions. A lithium interfacial ASR (ASR_{interface}) is calculated from the interfacial resistance (R_{interface}), by the equation ASR_{interface}=R_{interface}*A/2, where A is the area of the electrodes in contact with the separator and the factor of 2 accounts for 2 interfaces when measured in a symmetric cell and R_{interface}=Rₜₒₜₐₗ−R_{bulk}.

As used herein “ASR” refers to area-specific resistance. ASR is measured using electrochemical impedance spectroscopy (EIS). EIS can be performed on a Biologic VMP3 instrument or an equivalent thereof. In an ASR measurement lithium contacts are deposited on two sides of a sample. An AC voltage of 25 mV rms is applied across a frequency of 300 kHz-0.1 mHz while the current is measured. EIS partitions the ASR into the bulk contribution and the interfacial ASR contribution, by resolving two semicircles in a Nyquist plot.

As used herein, the term “LIRAP” refers to a lithium rich antiperovskite and is used synonymously with “LOC” or “Li₃OCl”. The composition of LIRAP is aLi₂O+bLiX+cLiOH+dAl₂O₃ where X=Cl, Br, and/or I, a/b=0.7-9, c/a=0.01-1, d/a=0.001-0.1.

As used herein, the term “LPS+X” refers to a lithium conducting electrolyte comprising Li, P, S, and X, where X=Cl, Br, and/or I. For example, “LSPI” refers to a lithium conducting electrolyte comprising Li, P, S, and I. More generally, it is understood to include aLi₂S+bP₂S_{y}+cLiX where X=Cl, Br, and/or I and where y=3-5 and where a/b=2.5-4.5 and where (a+b)/c=0.5-15.

As used herein, “LSS” refers to lithium silicon sulfide which can be described as Li₂S—SiS₂, Li—SiS₂, Li—S—Si, and/or a catholyte consisting essentially of Li, S, and Si. LSS refers to an electrolyte material characterized by the formula LiₓSi_{y}S_{z} where 0.33≤x≤0.5, 0.1≤y≤0.2, 0.4≤z≤0.55, and it may include up to 10 atomic % oxygen. LSS also refers to an electrolyte material comprising Li, Si, and S. In some examples, LSS is a mixture of Li₂S and SiS₂. In some examples, the ratio of Li₂S:SiS₂ is 90:10, 85:15, 80:20, 75:25, 70:30, 2:1, 65:35, 60:40, 55:45, or 50:50 molar ratio. LSS may be doped with compounds such as LiₓPO_{y}, LiₓBO_{y}, Li₄SiO₄, Li₃MO₄, Li₃MO₃, PSₓ, and/or lithium halides such as, but not limited to, LiI, LiCl, LiF, or LiBr, wherein 0<x≤5 and 0<y≤5.

As used herein, the term “SLOPS” refers to unless otherwise specified, a 60:40 molar ratio of Li₂S:SiS₂ with 0.1-10 mol. % Li₃PO₄. In some examples, “SLOPS” includes Li₁₀Si₄Si₃ (50:50 Li₂S:SiS₂) with 0.1-10 mol. % Li₃PO₄. In some examples, “SLOPS” includes Li₂₆Si₇S₂₇ (65:35 Li₂S:SiS₂) with 0.1-10 mol. % Li₃PO₄. In some examples, “SLOPS” includes Li₄SiS₄ (67:33 Li₂S:SiS₂) with 0.1-5 mol. % Li₃PO₄. In some examples, “SLOPS” includes Li₁₄Si₃S₁₃ (70:30 Li₂S:SiS₂) with 0.1-5 mol. % Li₃PO₄. In some examples, “SLOPS” is characterized by the formula (1−x)(60:40 Li₂S:SiS₂)*(x)(Li₃PO₄), wherein x is from 0.01 to 0.99. As used herein, “LBS-POX” refers to an electrolyte composition of Li₂S:B₂S₃:Li₃PO₄:LiX where X is a halogen (X=F, Cl, Br, I). The composition can include Li₃BS₃ or Li₅B₇S₁₃ doped with 0-30% lithium halide such as LiI and/or 0-10% Li₃PO₄.

As used herein, the term “LSTPS” refers to an electrolyte material having Li, Si, P, Sn, and S chemical constituents. As used herein, “LSPSO,” refers to LSPS that is doped with, or has, O present. In some examples, “LSPSO,” is a LSPS material with an oxygen content between 0.01 and 10 atomic %. As used herein, “LATP,” refers to an electrolyte material having Li, As, Sn, and P chemical constituents. As used herein “LAGP,” refers to an electrolyte material having Li, As, Ge, and P chemical constituents. As used herein, “LXPSO” refers to a catholyte material characterized by the formula LiₐMP_{b}S_{c}O_{d}, where M is Si, Ge, Sn, and/or Al, and where 2≤a≤8, 0.5≤b≤2.5, 4≤c≤12, and d<3. LXPSO refers to LXPS, as defined above, and having oxygen doping at from 0.1 to about 10 atomic %. LPSO refers to LPS, as defined above, and having oxygen doping at from 0.1 to about 10 atomic %.

As used herein, “LTS” refers to a lithium tin sulfide compound which can be described as Li₂S:SnS₂:As₂S₅, Li₂S—SnS₂, Li₂S—SnS, Li—S—Sn, and/or a catholyte consisting essentially of Li, S, and Sn. The composition may be LiₓSn_{y}S_{z} where 0.25≤x≤0.65, 0.05≤y≤0.2, and 0.25≤z≤0.65. In some examples, LTS is a mixture of Li₂S and SnS₂ in the ratio of 80:20, 75:25, 70:30, 2:1, or 1:1 molar ratio. LTS may include up to 10 atomic % oxygen. LTS may be doped with Bi, Sb, As, P, B, Al, Ge, Ga, and/or In and/or lithium halides such as, but not limited to, LiI, LiCl, LiF, or LiBr.

As used herein, the term “LATS” refers to an LTS further including Arsenic (As).

As used here, the term “transparent” refers to a material that has a transmission coefficient of greater than 0.9 when measured with incident light at a wavelength between 400-700 nm. As used here, the term “translucent” refers to a material that has a transmission coefficient of between 0.1-0.9 when measured with incident light at a wavelength between 400-700 nm.

As used herein, the phrase “transmission coefficient,” refers to the ratio of the amount of incident light which transmits through a material with respect to the total amount of incident light. A transmission coefficient of 0.5 means that half of the incident light which impinges upon a material transmits through that material.

As used herein, the term “thin film” refers to a film having the components, compositions, or materials described herein where the film has an average thickness dimension of about 10 nm to about 100 μm. In some examples, thin refers to a film that is less than about 1 μm, 10 μm, or 50 μm in thickness.

As used herein, the term “monolith,” refers to a separator having a density which is at least as dense as a film, but wherein the monolith is thicker than a thin film by at least a factor of two (2) or more. A monolith is to be distinguished from a composite in that a composite includes more than one type of material whereas a monolith is homogeneous and made of a single type of material. That is, a “monolith” refers to an object having a single or uniform body. A monolith is a “shaped, fabricated, intractable article with a homogeneous microstructure which does not exhibit any structural components distinguishable by optical microscopy.” Typical fabrication techniques for forming the article include, but are not limited to, cold pressing or hot pressing of a polymeric material, and using a reactive processing technique such as reaction injection molding, crosslinking, sol-gel processing, sintering, and the like As used herein, a monolith and a sintered film have substantially the same density when both are prepared substantially defect free. Herein, substantially defect free is a material having approximately 0.0001% defects per volume.

As used herein, the term “pellet” refers to a small unit of bulky material compressed into any of several shapes and sizes, e.g., cylindrical, rectangular, or spherical. The compressed material is disc-shaped and may be 5-20 cm in diameter and 0.5 to 2 cm in height. Typically, the compressed material is disc-shaped and 10 cm in diameter and 1 cm in height. Pellets may also include additional agents to help bind the material compressed into the pellet. In some examples, these additional agents are referred to as binding agents and may include, but are not limited to, polymers such as poly(ethylene)oxide. In some examples, polyvinyl butyral is used as a binding agent. Pellets are typically made by pressing a collection of powder materials in a press. This pressing makes the powder materials adhere to each other and increases the density of the collection of powder material when compared to the density of the collection of powder material before pressing. In some instances, the powder material is heated and/or an electrical current is passed through the powder material during the pressing.

As used herein, the term “pressed pellet” refers to a pellet having been submitted to a pressure (e.g., 5000 psi) to further compress the pellet.

As used herein, the term “oxide” refers to a chemical compound that includes at least one oxygen atom and one other element in the chemical formula for the chemical compound. For example, an “oxide” is interchangeable with “oxide electrolytes.” Non-limiting examples of oxide electrolytes are found, for example, in US Patent Application Publication No. 2015/0200420, published Jul. 16, 2015, the contents of which are incorporated herein by reference in their entirety.

As used herein, the term “sulfide” refers to refers to a chemical compound that includes at least one sulfur atom and one other element in the chemical formula for the chemical compound. For example, a “sulfide” is interchangeable with “sulfide electrolytes.” Non-limiting examples of sulfide electrolytes are found, for example, in U.S. Pat. No. 9,172,114, issued Oct. 27, 2015, and also in US Patent Application Publication No. 2017-0162901 A1, which published Jun. 8, 2017, and was filed as U.S. patent application Ser. No. 15/367,103 on Dec. 1, 2016, the entire contents of which are herein incorporated by reference in its entirety for all purposes.

As used herein, the term “sulfide-halide” refers to a chemical compound that includes at least one sulfur atom, at least one halogen atom, and one other element in the chemical formula for the chemical compound.

As used herein, the term “total effective lithium ion conductivity” of a material refers to L/R_{bulk}A, where L is the total thickness of the material, A is the measurement area, for example, the interfacial contact area of electrodes in contact with the material, and R_{bulk} is the bulk resistance of the material measured, for example, by electrochemical impedance spectroscopy.

As used herein, the term “LBHPS” refers to a lithium conducting electrolyte having, Li, B, H, P, and S. It is understood to include A(LiBH₄)(1−A)(P₂S₅) wherein 0.05≤A≤0.95.

As used herein, the term “conformally bonded” refers to the bonding of a composition to a substrate where the idiosyncratic defects of the substrate are unchanged yet masked or smoothened by the bonding of the composition to the substrate.

As used herein, the term “gravure coating” or “microgravure coating” refers to a process in which a substrate is contacted with a liquid via a roll-to-roll process. A roll surface is engraved with a pattern of cells that provide a desired coating volume. The roll is mounted in bearings and is rotated while partially submerged in a receptacle holding the liquid to be coated onto the substrate. Rotation of the roll permits the substrate to acquire the coating, which is pre-metered with a flexible blade (e.g., a doctor blade) as the roll rotates toward a contact point with the substrate. Typically, gravure coating includes a backing roll having approximately the same diameter as the engraved roll.

As used herein, the term “through-pores” in a material refers to a gap or void that extends through the entirety of the material.

As used herein, the term “surface pores” in a material refers to a gap, cavity, or void that resides at the surface of a substrate.

As used herein, the term “amorphous,” refers to a material that is not crystalline or that does not contain a majority crystalline phase. Amorphous refers to a material that does not evidence a crystalline property, for example, well-defined x-ray diffraction peaks as measured by x-ray diffraction. An amorphous material is at least primarily amorphous and characterized as having more amorphous components than crystalline components. Substantially amorphous refers to a material that does not include well defined x-ray diffraction peaks or that is characterized by an x-ray diffraction pattern that includes broad reflections that are recognized by a person having ordinary skill in the art as having the majority constituent component phase as an amorphous phase. A material that is substantially amorphous may have nano-sized domains of crystallinity, but which are still characterized by an x-ray diffraction pattern to be primarily in an amorphous phase. In a substantially amorphous material, transmission electron microscopy (TEM) selected area diffraction pattern (SADP) may evidence regions of crystallinity, but would also evidence a majority of the volume of the material as amorphous.

As used herein, the term “semiamorphous” or “semi-crystalline” refers to a composition having both crystalline and amorphous domains. A semi-crystalline material includes both nanocrystalline and/or microcrystalline components in addition to amorphous components. A semi-crystalline material is a material that is partially crystallized or is a material that includes some crystalline bulk and some amorphous bulk. For example, a material heated to its crystallization temperature, but subsequently cooled before the entirety of the material is able to crystallize, completely, is referred to herein as semi-crystalline material. As used herein, a semi-crystalline material can be characterized by an XRD powder pattern in which the primary peak of highest intensity has a full width at half maximum of at least 1° (2Θ), or at least 2° (2Θ), or at least 3° (2Θ).

As used herein, “SLOBS” includes, unless otherwise specified, a 60:40 molar ratio of Li₂S:SiS₂ with 0.1-10 mol. % LiBH₄. In some examples, “SLOBS” includes Li₁₀Si₄S₁₃ (50:50 Li₂S:SiS₂) with 0.1-10 mol. % LiBH₄. In some examples, “SLOBS” includes Li₂₆Si₇S₂₇ (65:35 Li₂S:SiS₂) with 0.1-10 mol. % LiBH₄. In some examples, “SLOBS” includes Li₄SiS₄ (67:33 Li₂S:SiS₂) with 0.1-5 mol. % LiBH₄. In some examples, “SLOBS” includes Li₁₄Si₃S₁₃ (70:30 Li₂S:SiS₂) with 0.1-5 mol. % LiBH₄. In some examples, “SLOBS” is characterized by the formula (1−x)(60:40 Li₂S:SiS₂)*(x)(Li₃BO₄), wherein x is from 0.01 to 0.99. As used herein, “LBS-BOX” refers to an electrolyte composition of Li₂S:B₂S₃:LiBH₄:LiX where X is a halogen (X=F, Cl, Br, I). The composition can include Li₃BS₃ or Li₅B₇S₁₃ doped with 0-30% lithium halide such as LiI and/or 0-10% Li₃PO₄.

As used herein, the phrase “characterized by the formula” refers to a description of a chemical compound by its chemical formula.

As used herein, the phrase “doped with Nb, Ga, and/or Ta” means that Nb, Ga, and/or Ta is used to replace certain components of another material, for example, a garnet. A lithium-stuffed garnet that is doped with Nb, Ga, and/or Ta refers to a lithium-stuffed garnet wherein Nb, Ga, and/or Ta substitutes for an element in the lithium-stuffed garnet chemical formula, which may be, for example, Li and/or Zr.

As used herein, the term “defect” refers to an imperfection or a deviation from a pristine structure that interacts with (i.e., absorbs, scatters, reflects, refracts, and the like) light. Defects may include, but are not limited to, a pore, a grain boundary, a dislocation, a crack, a separation, a chemical inhomogeneity, or a phase segregation of two or more materials in a solid material. A perfect crystal is an example of a material that lacks defects. A nearly 100% dense oxide electrolyte that has a planar surface, with substantially no pitting, inclusions, cracks, pores, or divots on the surface, is an example of an electrolyte that is substantially lacking defects. Defects can include a second phase inclusion (e.g., a Li₂S phase inside a LPSI electrolyte). Defects can include a pore inclusion. Defects can include a grain boundary wherein two adjacent grains have a region where their separation is greater than 10 nm. Defects can include pores in a porous separator.

As used herein, the term “about” when qualifying a number, e.g., about 15% w/w, refers to the number qualified and optionally the numbers included in a range about that qualified number that includes ±10% of the number. For example, about 15 w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, the phrase “charge neutral” refers to two or more elements of a chemical compound having an ionic charge where the sum of the ionic charges is zero. For example, the phrase “wherein u, v, x, y, and z are selected so that the lithium-stuffed garnet oxide is charge neutral” refers to the summation of ionic charges equaling zero for each element the u, v, x, y, or z refers to.

As used herein, the phrase “transmission properties of the composition vary by less than 50% over a surface area of at least 100 μm²” refers to a property (e.g., transmission coefficient) which is constant, uniform, or includes the given variance over the given surface area or volume.

As used herein, the phrase “bonded to defects” refers to a composition that is fixed to a substrate having imperfections. For example, a composition bonded to defects—as defined herein—includes infilling, joining, or passivation of a substrate having imperfections.

As used herein the term “porous” or “porosity” refers to a material that includes pores, e.g., nanopores, mesopores, or micropores. Porosity can be controlled with hot pressing or calendering. For example, porosity less than 5% can be achieved with calendering.

As used herein, the phrase “porosity as determined by SEM” refers to measurement of density by using image analysis software to analyze a scanning electron micrograph. For example, first, a user or software assigns pixels and/or regions of an image as porosity. Second, the area fraction of those regions is summed. Finally, the porosity fraction determined by SEM is equal to the area fraction of the porous region of the image.

As used herein, the phrases “electrochemical cell” or “battery cell” shall mean a single cell including a positive electrode and a negative electrode, which have ionic communication between the two using an electrolyte. In some embodiments, the same battery cell includes multiple positive electrodes and/or multiple negative electrodes enclosed in one container.

As used herein the phrase “electrochemical stack,” refers to one or more units which each include at least a negative electrode (e.g., Li, LiC₆), a positive electrode (e.g., Li-nickel-manganese-oxide or FeF₃, optionally combined with a solid-state electrolyte or a gel electrolyte), and a solid electrolyte (e.g., an oxide electrolyte set forth herein) between and in contact with the positive and negative electrodes. In some examples, between the solid electrolyte and the positive electrode, there is an additional layer comprising a compliant (e.g., gel electrolyte). An electrochemical stack may include one of these aforementioned units. An electrochemical stack may include several of these aforementioned units arranged in electrical communication (e.g., serial or parallel electrical connection). In some examples, when the electrochemical stack includes several units, the units are layered or laminated together in a column. In some examples, when the electrochemical stack includes several units, the units are layered or laminated together in an array. In some examples, when the electrochemical stack includes several units, the stacks are arranged such that one negative electrode is shared with two or more positive electrodes. Alternatively, in some examples, when the electrochemical stack includes several units, the stacks are arranged such that one positive electrode is shared with two or more negative electrodes. Unless specified otherwise, an electrochemical stack includes one positive electrode, one solid electrolyte, and one negative electrode, and optionally includes a bonding layer between the positive electrode and the solid electrolyte.

As used here, the phrase “positive electrode,” refers to the electrode in a secondary battery towards which positive ions, e.g., Lit, conduct, flow, or move during discharge of the battery. As used herein, the phrase “negative electrode” refers to the electrode in a secondary battery from where positive ions, e.g., Lit, flow, or move during discharge of the battery. In a battery comprised of a Li-metal electrode and a conversion chemistry, intercalation chemistry, or combination conversion/intercalation chemistry-including electrode (i.e., cathode active material; e.g., NiFₓ, NCA, LiNiₓMn_{y}CO_{z}O₂ [NMC] or LiNiₓAl_{y}CO_{z}O₂ [NCA], wherein x+y+z=1), the electrode having the conversion chemistry, intercalation chemistry, or combination conversion/intercalation chemistry material is referred to as the positive electrode. In some common usages, cathode is used in place of positive electrode, and anode is used in place of negative electrode. When a Li-secondary battery is charged, Li ions move from the positive electrode (e.g., NiFₓ, NMC, NCA) towards the negative electrode (e.g., Li-metal). When a Li-secondary battery is discharged, Li ions move towards the positive electrode and from the negative electrode.

As used herein, the term “surface roughness” refers to a measurement of either an arithmetic average of absolute values of sampled surface roughness amplitudes or a measurement of the maximum peak height of sampled surface roughness amplitudes. As used herein, the term, “Ra,” is a measure of surface roughness wherein Ra is an arithmetic average of absolute values of sampled surface roughness amplitudes. Surface roughness measurements can be accomplished using, for example, a Keyence VK-X100 instrument that measures surface roughness using a laser. As used herein, the term, “Rt,” is a measure of surface roughness wherein Rt is the maximum peak height of sampled surface roughness amplitudes.

As used herein, the term “roughened” refers to a surface that has a determined surface roughness.

As used herein, the term “rational number” refers to any number which can be expressed as the quotient or fraction (e.g., p/q) of two integers (e.g., p and q), with the denominator (e.g., q) not equal to zero. Example rational numbers include, but are not limited to, 1, 1.1, 1.52, 2, 2.5, 3, 3.12, and 7.

As used herein, voltage is set forth with respect to lithium (i.e., V vs. Li) metal unless stated otherwise.

As used herein, “powder mixture decomposition temperature” refers to the temperature at which the powder mixture starts to evolve hydrogen in appreciable rates so that the stoichiometry of the finished product is changed by more than 1% with respect to its stoichiometry.

As used herein, “binder” refers to a polymer with the capability to increase the adhesion and/or cohesion of an electrode. Suitable binders are known to those skilled in the art and may include PVDF, PVDF-HFP, SBR, and ethylene alpha-olefin copolymer.

### General

This disclosure describes a remedy for the expected high impedance between a solid electrolyte and solid-state cathode by introducing a high conductivity intermediate bonding layer that produces good contact between the solid-state separator and solid state cathode. To produce a commercially viable battery, overall cell impedance must be low. in one continuous conductive path via a scalable method. This invention describes a method to introduce an intermediate bonding layer in between a solid state separator and solid state cathode to adequately bond the two components and result with low interfacial and total impedances.

### GENERAL EMBODIMENTS

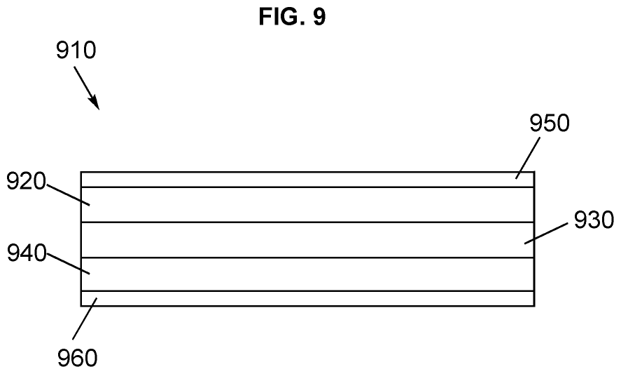

Referring to the Drawing, FIG. 9 shows one embodiment of an energy storage device, generally designated 910. The energy storage device includes a cathode 920, an anode 940, a solid-state ion conductor 930 positioned between the positive electrode and the anode, and current collectors 950 and 960, corresponding to a positive electrode current collector 950 and an anode current collector 960, respectively. In this embodiment, the solid-state ion conductor 930 may be an uncoated garnet configured to electrically insulate the positive electrode from the anode, while still allowing ion conduction (e.g., lithium ions) between the positive electrode and the anode during operation of energy storage device 910.

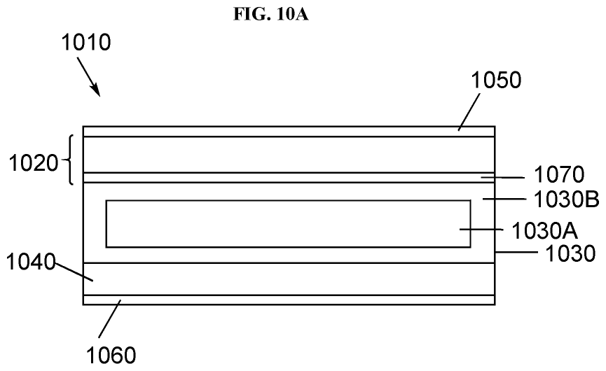

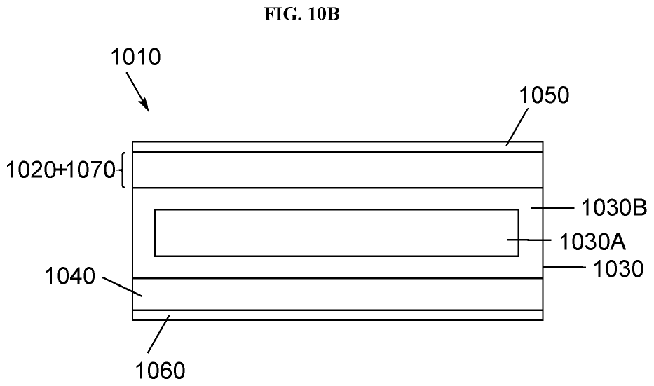

Now referring to FIG. 10A, shown is another embodiment of an energy storage device 1010. This embodiment also includes a cathode 1020, an anode 1040, a solid-state conductor 1030 positioned between the positive electrode and the anode, and current collectors 1050 and 1060 corresponding to a positive electrode current collector and an anode current collector, respectively. In this embodiment, the solid-state ion conductor 1030 may be configured as a coated garnet 1030A, also configured to electrically insulate the positive electrode from the anode, while still allowing ionic flow (e.g., lithium ions) between the positive electrode and the anode during operation of energy storage device 1010. In this embodiment, a coating 1030B may surround the coated garnet 1030A. In an alternate embodiment, the coating 1030B may be only or primarily on the anode-side of separator 1030A. In an alternate embodiment, the coating 1030B may be only or primarily on the cathode-side of separator 30A. Further, in this embodiment, cathode 1020 includes a cathode-facing separator 1070 positioned between coating 1030B and cathode 1020. For clarity purposes, cathode-facing separator 1070 is depicted as a layer. In certain embodiments, however, catholyte 1070 may penetrate, soak into, and/or be interspersed or infiltrate throughout cathode 100 while still being positioned between cathode 1020 and coating 1030B, as in FIG. 10B. For example, in FIG. 10B, catholyte 1070 may remain in contact with each of the cathode 1020 and the solid-state conductor 1030. Interestingly, Applicants have unexpectedly observed improved performance of 1010 due to the reduced degradation or decomposition of solid state ion conductor 1030 due to the presence of coating 1030B. Alternatively stated, coating 1030B minimizes the reactions of coated garnet 1030A with the anode 1040, such as those involving lithium dendrites, under typical operating conditions for energy storage device 1010.

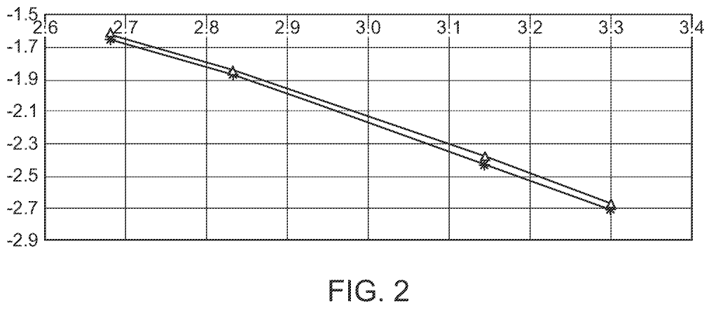

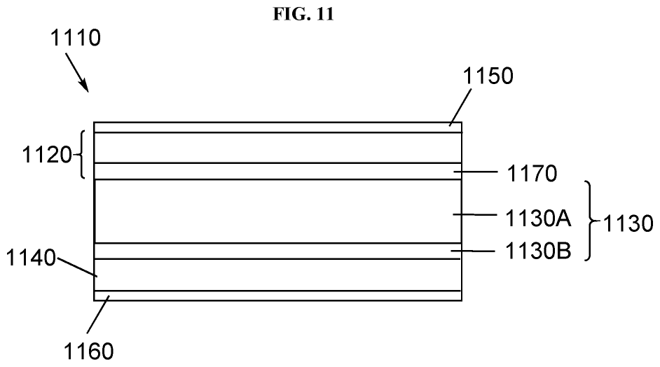

Referring now to FIG. 11, shown is another embodiment of an energy storage device 1110. This embodiment also includes a cathode 1120, an anode 1140, a solid-state conductor 1130 positioned between the cathode 1120 and the anode 1140, and current collectors 1150 and 1160 corresponding to a cathode current collector and an anode current collector, respectively. In this embodiment, the solid-state ion conductor 1130 may be configured as a coated garnet 1130A, also configured to electrically insulate the positive electrode from the anode, while still allowing ionic flow (e.g., lithium ions) between the cathode 1120 and the anode 1140 during operation of energy storage device 1110. In this embodiment, a coating 1130B may coat one portion of the coated garnet 1130A. As in FIG. 2A, cathode 1120 also includes a catholyte 1170 positioned between solid state conductor 1130 and cathode 1120. In certain embodiments similar to FIG. 2B, catholyte 1170 may penetrate, soak into, and/or be interspersed or infiltrate cathode 1120 while still being positioned between cathode 1120 and solid-state conductor 1130. In this embodiment, Applicants have also unexpectedly observed improved performance of 1110 due to the reduced degradation or decomposition of 1130A due to the presence of coating 1130B. Alternatively stated, coating 1130B minimizes reaction of coated garnet 1130A with the anode 1140 under typical operating conditions for energy storage device 1110.

### Compositions

In certain embodiments, coating 1030B, as in FIG. 10A or 10B, or 1130B, as in FIG. 11, may include a composition having A(LiBH₄)(1−A)(P₂S₅) wherein 0.05≤A≤0.95. In some examples, A is 0.05. In some examples, A is 0.1. In some examples, A is 0.15. In some examples, A is 0.2. In some examples, A is 0.25. In some examples, A is 0.3. In some examples, A is 0.35. In some examples, A is 0.4. In some examples, A is 0.45. In some examples, A is 0.5. In some examples, A is 0.55. In some examples, A is 0.6. In some examples, A is 0.65. In some examples, A is 0.7. In some examples, A is 0.75. In some examples, A is 0.8. In some examples, A is 0.85. In some examples, A is 0.9. In some examples, A is 0.95.

In certain embodiments, the LBHPS bonding layer may include a composition having A(LiBH₄)(1−A)(P₂S₅) wherein 0.05≤A≤0.95. In some examples, A is 0.05. In some examples, A is 0.1. In some examples, A is 0.15. In some examples, A is 0.2. In some examples, A is 0.25. In some examples, A is 0.3. In some examples, A is 0.35. In some examples, A is 0.4. In some examples, A is 0.45. In some examples, A is 0.5. In some examples, A is 0.55. In some examples, A is 0.6. In some examples, A is 0.65. In some examples, A is 0.7. In some examples, A is 0.75. In some examples, A is 0.8. In some examples, A is 0.85. In some examples, A is 0.9. In some examples, A is 0.95.

In one embodiment, the composition may be about 0.95LiBH₄.0.05P₂S₅. In another embodiment, the composition may be about 0.05LiBH₄.0.95P₂S₅. In another embodiment, the composition may be about 0.9LiBH₄.0.1P₂S₅. In another embodiment, the composition may be about 0.85LiBH₄.0.15P₂S₅. In another embodiment, the composition may be about 0.8LiBH₄.0.2P₂S₅. In another embodiment, the composition may be about 0.75LiBH₄.0.25P₂S₅. In another embodiment, the composition may be about 0.7LiBH₄.0.3P₂S₅. In another embodiment, the composition may be about 0.65LiBH₄.0.35P₂S₅. In another embodiment, the composition may be about 0.6LiBH₄.0.4P₂S₅. In another embodiment, the composition may be about 0.55LiBH₄.0.45P₂S₅. In another embodiment, the composition may be about 0.1LiBH₄.0.9P₂S₅.

In some embodiments, the composition may exist in different physical states. For example, in one embodiment, the composition may be amorphous. By way of further example, in one embodiment, the composition may be semi-crystalline. By way of further example, in one embodiment, the composition may be polycrystalline. The composition can be made amorphous or semi-crystalline by controlling the sintering profile, e.g., by adjusting the cooling rate after sintering.

In certain embodiments, the composition may impart an ionic conductivity beneficial to the operation of the energy storage device 910, as in FIG. 9, 1010, as in FIG. 10A or 10B, or 1110, as in FIG. 11. In certain embodiments, the composition may impart an ionic conductivity beneficial to the operation of the energy storage device. In one embodiment, the composition may include a lithium ion conductivity greater than 1×10⁻⁷ S/cm at 45° C. By way of further example, in one embodiment, the composition may include a lithium ion conductivity greater than 1×10⁻⁶ S/cm at 45° C. By way of further example, in one embodiment, the composition may include a lithium ion conductivity greater than 1×10⁻⁵ S/cm at 45° C. By way of further example, in one embodiment, the composition may include a lithium ion conductivity greater than 1×10⁻⁴ S/cm at 45° C. By way of further example, in one embodiment, the total effective lithium ion conductivity is greater than 10⁻³ S/cm at 45° C.

In certain embodiments, the composition may impart an ionic conductivity beneficial to the operation of the energy storage device 910, as in FIG. 9, 1010, as in FIG. 10A or 10B, or 1110, as in FIG. 11. In one embodiment, the composition may include a lithium ion conductivity greater than 1×10⁻⁷ S/cm at 60° C. By way of further example, in one embodiment, the composition may include a lithium ion conductivity greater than 1×10⁻⁶ S/cm at 60° C. By way of further example, in one embodiment, the composition may include a lithium ion conductivity greater than 1×10⁻⁵ S/cm at 60° C. By way of further example, in one embodiment, the composition may include a lithium ion conductivity greater than 1×10⁻⁴ S/cm at 60° C. By way of further example, in one embodiment, the total effective lithium ion conductivity is greater than 10'S/cm at 60° C. By way of further example, in one embodiment, the total effective lithium ion conductivity is greater than 8×10⁻⁴ S/cm at 60° C.

In certain embodiments, the LBHPS composition may exist as a film, a single entity, or a pellet. For example, in one embodiment, the composition is a thin film. By way of further example, in one embodiment, the composition is a monolith. By way of further example, in one embodiment, the composition is a pressed pellet.

In some embodiments, the LBHPS composition may be bonded to a solid-state cathode. For example, in one embodiment, the solid-state cathode may be Li_{1±a}(NiₓMn_{y}Co_{z})O_{2±δ} (NMC), LSPSCl and ethylene alpha-olefin copolymer. In some embodiments, the solid-state cathode is made of NMC, LSPSCl and ethylene alpha-olefin copolymer and carbon. In some embodiments, the solid-state cathode is made of NCA, LSPSCl and ethylene alpha-olefin copolymer. In some embodiments, the solid-state cathode is made of Li_{1±a}Ni_{0.8}Co_{1.15}Al_{0.05}O₂ (NCA), LSTPS, ethylene alpha-olefin copolymer and carbon.

In some embodiments, the LBHPS composition may further include an oxide, a sulfide, a sulfide-halide, or an electrolyte. For example, in one embodiment, the oxide may be selected from a lithium-stuffed garnet characterized by the formula LiₓLa_{y}Zr_{z}Oₜ.qAl₂O₃, wherein 4<x<10, 1<y<4, 1<z<3, 6<t<14, 0≤q≤1. By way of further example, in one embodiment, the composition includes an oxide with a coating of LBHPS, where the oxide may be selected from a lithium-stuffed garnet characterized by the formula LiₓLa_{y}.Zr_{z}Oₜ.qAl₂O₃, wherein 4<x<10, 1<y<4, 1<z<3, 6<t<14, 0≤q≤1. By way of further example, in one embodiment, the oxide may be selected from a lithium-stuffed garnet characterized by the formula LiₐLa_{b}Zr_{c}Al_{d}Me″ₑO_{f}, wherein 5<a<8.5; 2<b<4; 0<c≤2.5; 0≤d<2; 0≤e<2, and 10<f<13 and Me″ is a metal selected from Nb, Ga, Ta, or combinations thereof. By way of further example, in one embodiment, the composition includes an oxide with a coating of LBHPS, where the oxide may be selected from a lithium-stuffed garnet characterized by the formula LiₐLa_{b}Zr_{c}Al_{d}Me″ₑO_{f}, wherein 5<a<8.5; 2<b<4; 0<c≤2.5; 0≤d<2; 0≤e<2, and 10<f<13 and Me″ is a metal selected from Nb, Ga, Ta, or combinations thereof. By way of further example, in one LiₐLa_{b}Zr_{c}Al_{d}Me″ₑO_{f} embodiment as above, Me″ is Nb. By way of further example, in one LiₐLa_{b}Zr_{c}Al_{d}Me″ₑO_{f} embodiment as above, Me″ is Ga. By way of further example, in one LiₐLa_{b}Zr_{c}Al_{d}Me″ₑO_{f} embodiment as above, Me″ is Ta. By way of further example, in one LiₐLa_{b}Zr_{c}Al_{d}Me″ₑO_{f} embodiment as above, Me″ is Nb and Ga. By way of further example, in one LiₐLa_{b}Zr_{c}Al_{d}Me″ₑO_{f} embodiment as above, Me″ is Nb and Ta. By way of further example, in one LiₐLa_{b}Zr_{c}Al_{d}Me″ₑO_{f} embodiment as above, Me″ is Ga and Ta. By way of further example, in one embodiment, the oxide is a lithium-stuffed garnet oxide characterized by the formula LiᵤLaᵥZrₓO_{y}.zAl₂O₃, wherein
u is a rational number from 4 to 8;
v is a rational number from 2 to 4;
x is a rational number from 1 to 3;
y is a rational number from 10 to 14; and
z is a rational number from 0.05 to 1;
   wherein u, v, x, y, and z are selected so that the lithium-stuffed garnet oxide is charge neutral. By way of further example, in one embodiment, the composition includes an oxide with a coating of LBHPS, where the oxide is a lithium-stuffed garnet oxide characterized by the formula LiᵤLaᵥZrₓO_{y}.zAl₂O₃, wherein
u is a rational number from 4 to 8;
v is a rational number from 2 to 4;
x is a rational number from 1 to 3;
y is a rational number from 10 to 14; and
z is a rational number from 0.05 to 1;
   wherein u, v, x, y, and z are selected so that the lithium-stuffed garnet oxide is charge neutral. By way of further example, in one embodiment, the oxide is a lithium-stuffed garnet oxide characterized by the formula LiᵤLaᵥZrₓO_{y}.zTa₂O₅, wherein
u is a rational number from 4 to 10;
v is a rational number from 2 to 4;
x is a rational number from 1 to 3;
y is a rational number from 10 to 14; and
z is a rational number from 0 to 1;
   wherein u, v, x, y, and z are selected so that the lithium-stuffed garnet oxide is charge neutral. By way of further example, in one embodiment, the composition includes an oxide with a coating of LBHPS, where the oxide is a lithium-stuffed garnet oxide characterized by the formula LiᵤLaᵥZrₓO_{y}.zTa₂O₅, wherein
u is a rational number from 4 to 10;
v is a rational number from 2 to 4;
x is a rational number from 1 to 3;
y is a rational number from 10 to 14; and
z is a rational number from 0 to 1;
   wherein u, v, x, y, and z are selected so that the lithium-stuffed garnet oxide is charge neutral. By way of further example, in one embodiment, the oxide is a lithium-stuffed garnet oxide characterized by the formula LiᵤLaᵥZrₓO_{y}.zNb₂O₅, wherein
u is a rational number from 4 to 10;
v is a rational number from 2 to 4;
x is a rational number from 1 to 3;
y is a rational number from 10 to 14; and
z is a rational number from 0 to 1;
   wherein u, v, x, y, and z are selected so that the lithium-stuffed garnet oxide is charge neutral. By way of further example, in one embodiment, the composition includes an oxide with a coating of LBHPS, where the oxide is a lithium-stuffed garnet oxide characterized by the formula LiᵤLaᵥZrₓO_{y}.zNb₂O₅, wherein
u is a rational number from 4 to 10;
v is a rational number from 2 to 4;
x is a rational number from 1 to 3;
y is a rational number from 10 to 14; and
z is a rational number from 0 to 1;
   wherein u, v, x, y, and z are selected so that the lithium-stuffed garnet oxide is charge neutral. By way of further example, in one embodiment, the oxide is a lithium-stuffed garnet oxide characterized by the formula LiᵤLaᵥZrₓO_{y}.zGa₂O₃, wherein
u is a rational number from 4 to 10;
v is a rational number from 2 to 4;
x is a rational number from 1 to 3;
y is a rational number from 10 to 14; and
z is a rational number from 0 to 1;
   wherein u, v, x, y, and z are selected so that the lithium-stuffed garnet oxide is charge neutral. By way of further example, in one embodiment, the composition includes an oxide with a coating of LBHPS, where the oxide is a lithium-stuffed garnet oxide characterized by the formula LiᵤLaᵥZrₓO_{y}.zGa₂O₃, wherein
u is a rational number from 4 to 10;
v is a rational number from 2 to 4;
x is a rational number from 1 to 3;
y is a rational number from 10 to 14; and
z is a rational number from 0 to 1;
   wherein u, v, x, y, and z are selected so that the lithium-stuffed garnet oxide is charge neutral. By way of further example, in one embodiment, the oxide is a lithium-stuffed garnet oxide characterized by the formula LiᵤLaᵥZrₓO_{y}.zTa₂O₅.bAl₂O₃, wherein
u is a rational number from 4 to 10;
v is a rational number from 2 to 4;
x is a rational number from 1 to 3;
y is a rational number from 10 to 14; and
z is a rational number from 0 to 1;
b is a rational number from 0 to 1;
wherein z+b≤1
   wherein u, v, x, y, and z are selected so that the lithium-stuffed garnet oxide is charge neutral. By way of further example, in one embodiment, the composition includes an oxide with a coating of LBHPS, where the oxide is a lithium-stuffed garnet oxide characterized by the formula LiᵤLaᵥZrₓO_{y}.zTa₂O₅.bAl₂O₃, wherein
u is a rational number from 4 to 10;
v is a rational number from 2 to 4;
x is a rational number from 1 to 3;
y is a rational number from 10 to 14; and
z is a rational number from 0 to 1;
b is a rational number from 0 to 1;
wherein z+b≤1
   wherein u, v, x, y, and z are selected so that the lithium-stuffed garnet oxide is charge neutral. By way of further example, in one embodiment, the oxide is a lithium-stuffed garnet oxide characterized by the formula LiᵤLaᵥZrₓO_{y}.zNb₂O₅.bAl₂O₃, wherein
u is a rational number from 4 to 10;
v is a rational number from 2 to 4;
x is a rational number from 1 to 3;
y is a rational number from 10 to 14; and
z is a rational number from 0 to 1;
b is a rational number from 0 to 1;
wherein z+b≤1
   wherein u, v, x, y, and z are selected so that the lithium-stuffed garnet oxide is charge neutral. By way of further example, in one embodiment, the composition includes an oxide with a coating of LBHPS, where the oxide is a lithium-stuffed garnet oxide characterized by the formula LiᵤLaᵥZrₓO_{y}.zNb₂O₅.bAl₂O₃, wherein
u is a rational number from 4 to 10;
v is a rational number from 2 to 4;
x is a rational number from 1 to 3;
y is a rational number from 10 to 14; and
z is a rational number from 0 to 1;
b is a rational number from 0 to 1;
wherein z+b≤1
   wherein u, v, x, y, and z are selected so that the lithium-stuffed garnet oxide is charge neutral. By way of further example, in one embodiment, the oxide is a lithium-stuffed garnet oxide characterized by the formula LiᵤLaᵥZrₓO_{y}.zGa₂O₃.bAl₂O₃, wherein
u is a rational number from 4 to 10;
v is a rational number from 2 to 4;
x is a rational number from 1 to 3;
y is a rational number from 10 to 14; and
z is a rational number from 0 to 1;
b is a rational number from 0 to 1;
   wherein z+b≤1 and wherein u, v, x, y, and z are selected so that the lithium-stuffed garnet oxide is charge neutral. By way of further example, in one embodiment, the composition includes an oxide with a coating of LBHPS, where the oxide is a lithium-stuffed garnet oxide characterized by the formula LiᵤLaᵥZrₓO_{y}.zGa₂O₃.bAl₂O₃, wherein
u is a rational number from 4 to 10;
v is a rational number from 2 to 4;
x is a rational number from 1 to 3;
y is a rational number from 10 to 14; and
z is a rational number from 0 to 1;
b is a rational number from 0 to 1;
   wherein z+b≤1 and wherein u, v, x, y, and z are selected so that the lithium-stuffed garnet oxide is charge neutral. By way of further example, in one embodiment, the oxide is Li_{6.4}Ga_{0.2}La₃Zr₂O₁₂ where the subscripts and molar coefficients in the empirical formula are based on the quantities of raw materials initially batched to make the described Li_{6.4}Ga_{0.2}La₃Zr₂O₁₂.

In certain embodiments, the lithium-stuffed garnet LiₓLa_{y}Zr_{z}Oₜ.qAl₂O₃ may be doped with Nb, Ga, and/or Ta. By way of further example, in one embodiment, the lithium-stuffed garnet LiₓLa_{y}Zr_{z}Oₜ.qAl₂O₃ may be doped with Nb, Ga, and Ta. By way of further example, in one embodiment, the lithium-stuffed garnet LiₓLa_{y}Zr_{z}Oₜ.qAl₂O₃ may be doped with Nb, Ga, or Ta. By way of further example, in one embodiment, the lithium-stuffed garnet LiₓLa_{y}Zr_{z}Oₜ.qAl₂O₃ may be doped with Nb. By way of further example, in one embodiment, the lithium-stuffed garnet LiₓLa_{y}Zr_{z}Oₜ.qAl₂O₃ may be doped with Ga. By way of further example, in one embodiment, the lithium-stuffed garnet LiₓLa_{y}Zr_{z}Oₜ.qAl₂O₃ may be doped with Ta.

In some embodiments, the sulfide or sulfide-halide may be selected from the group consisting of LSS, SLOPS, LSTPS, SLOBS, LATS, and LPS+X, wherein X is selected from Cl, I, or Br. For example, in one embodiment, the sulfide or sulfide-halide may be LSS. By way of further example, in one embodiment, the sulfide or sulfide-halide may be SLOPS. By way of further example, in one embodiment, the sulfide or sulfide-halide may be LSTPS. By way of further example, in one embodiment, the sulfide or sulfide-halide may be SLOBS. By way of further example, in one embodiment, the sulfide or sulfide-halide may be LATS. By way of further example, in one embodiment, the sulfide or sulfide-halide may be LPS+X, wherein X is selected from Cl, I, or Br. By way of further example, the sulfide or sulfide halide may be LPS+X where LPS+X may be LPSCl. By way of further example, the sulfide or sulfide halide may be LPS+X where LPS+X may be LPSBr. By way of further example, the sulfide or sulfide halide may be LPS+X where LPS+X may be LPSI. By way of further example, the sulfide halide may be LiₐSi_{b}P_{c}S_{d}Xₑ, wherein 8<a<12, 1<b<3, 1<c<3, 8<d<14, and 0<X<1, wherein X is F, Cl, Br, or I. By way of further example, in one embodiment, the sulfide halide may be LiₐSi_{b}P_{c}S_{d}Xₑ, wherein 8<a<12, 1<b<3, 1<c<3, 8<d<14, and 0<X<1, wherein X is F. By way of further example, in one embodiment, the sulfide halide may be LiₐSi_{b}P_{c}S_{d}Xₑ, wherein 8<a<12, 1<b<3, 1<c<3, 8<d<14, and 0<X<1, wherein X is Cl. By way of further example, in one embodiment, the sulfide halide may be LiₐSi_{b}P_{c}S_{d}Xₑ, wherein 8<a<12, 1<b<3, 1<c<3, 8<d<14, and 0<X<1, wherein X is Br. By way of further example, in one embodiment, the sulfide halide may be LiₐSi_{b}P_{c}S_{d}Xₑ, wherein 8<a<12, 1<b<3, 1<c<3, 8<d<14, and 0<X<1, wherein X is I. By way of further example, in one embodiment, the sulfide may be LiₐSi_{b}Sn_{c}P_{d}SₑO_{f}, wherein 2≤a≤8, 0≤b≤1, 0≤c≤1, b+c=1, 0.5≤d≤2.5, 4≤e≤12, and 0<f≤10. By way of further example, in one embodiment, the sulfide may be Li_{g}AsₕSnⱼSₖOₗ, wherein 2≤g≤6, 0≤h≤1, 0≤j≤1, 2≤k≤6, and 0≤l≤10. By way of further example, in one embodiment, the sulfide may be LiₘPₙSₚX_{q}, wherein X=Cl, Br, and/or I, 2≤m≤6, 0≤n≤1, 0≤p≤1, and 2≤q≤6. By way of further example, in one embodiment, the sulfide may be LiₘPₙSₚI_{q}, 2≤m≤6, 0≤n≤1, 0≤p≤1, and 2≤q≤6. By way of further example, in one embodiment, the sulfide may be a mixture of (Li₂S):(P₂S₅) having a molar ratio from about 10:1 to about 6:4 and LiI, wherein the ratio of [(Li₂S):(P₂S₅)]:LiI is from 95:5 to 50:50. By way of further example, in one embodiment, the sulfide may be LPS+X, wherein X is selected from Cl, I, or Br. By way of further example, in one embodiment, the sulfide may be vLi₂S+wP₂S₅+yLiX wherein coefficients v, w, and y are rational numbers from 0 to 1. By way of further example, in one embodiment, the sulfide may be vLi₂S+wSiS₂+yLiX wherein coefficients v, w, and y are rational numbers from 0 to 1. By way of further example, in one embodiment, the sulfide may be vLi₂S+wSiS₂+yLiX wherein coefficients v, w, and y are rational numbers from 0 to 1. By way of further example, in one embodiment, the sulfide may be vLi₂S+wB₂S₃+yLiX wherein coefficients v, w, and y are rational numbers from 0 to 1. By way of further example, in one embodiment, the sulfide may be vLi₂S+wB₂S₃+yLiX wherein coefficients v, w, and y are rational numbers from 0 to 1.

In some embodiments, the LBHPS extends into the surface cavities of the sulfide-halide. In some embodiments, the LBHPS coats the surface cavities of the sulfide-halide.

In some embodiments, the LBHPS extends into the surface cavities of the lithium-stuffed garnet. In some embodiments, the LBHPS coats the surface cavities of the lithium-stuffed garnet.

In some embodiments, the electrolyte may be selected from the group consisting of:

a mixture of LiI and Al₂O₃; Li₃N; LIRAP; LATP; LAGP; a mixture of LiBH₄ and LiX wherein X is selected from Cl, I, or Br; and vLiBH₄+wLiX+yLiNH₂, wherein X is selected from Cl, I, or Br; wherein coefficients v, w, and y are rational numbers from 0 to 1. For example, in one embodiment, the electrolyte may be a mixture of LiI and Al₂O₃, Li₃N, LIRAP, a mixture of LiBH₄ and LiX wherein X is selected from Cl, I, or Br, or vLiBH₄+wLiX+yLiNH₂ wherein X is selected from Cl, I, or Br and wherein coefficients v, w, and y are rational numbers from 0 to 1.

In certain embodiments, the composition may include a lithium interfacial area-specific resistance. For example, in one embodiment, the lithium interfacial area-specific resistance is less than 20 Ωcm² at 25° C.

In certain embodiments, the composition may further include a transmission coefficient at a particular incident wavelength. For example, in one embodiment, the composition has a transmission coefficient of greater than 0.05 at 500 nm incident wavelength. In another embodiment, the composition may also include transmission properties that vary by less than a percentage over a surface area of the composition. For example, in one embodiment, the composition has a transmission coefficient of greater than 0.05 at 500 nm incident wavelength and the transmission properties of the composition vary by less than 50% over a surface area of at least 100 μm². In another embodiment, the composition may have a transmission coefficient or greater than 0.05 at 500 nm incident wavelength and the composition is less than 1 mm thick.

Referring again to FIG. 10A, 10B, or 11, in certain embodiments, a solid state ion conductor composition 1030 or 1030 may include a lithium-stuffed garnet 1030A or 1130A, as described elsewhere herein, and a composition 1030B or 1130A having A(LiBH₄)(1−A)(P₂S₅) wherein 0.05≤A≤0.95 or a lithium borohydride (LBH), as described elsewhere herein, where the LBHPS coats a surface of the lithium-stuffed garnet. Typically, during the operation of an energy storage device, lithium tends to plate out unevenly, or form lithium dendrites, onto surfaces with defects. Upon lithium dendrite formation, lithium also tends to cause energy storage device failures in the form of shorting. Applicants have unexpectedly observed that LBHPS coating compositions provided herein remove or fill surface defects by coating the defects, thereby extending the lifetimes for energy storage devices. For example, in one embodiment, the LBHPS may be conformally bonded to the surface of the lithium-stuffed garnet. By way of further example, in one embodiment, the LBHPS may be bonded to defects in the lithium-stuffed garnet.

Referring again to FIG. 10A, 10B, or 11, in certain embodiments, a solid state ion conductor composition 1030 or 1130 may include a lithium-stuffed garnet 1030A or 1130A, as described elsewhere herein, and a composition 1030B or 1130A having A(LiBH₄)(1−A)(P₂S₅) wherein 0.05≤A≤0.95 or a lithium borohydride (LBH), as described elsewhere herein, where the LBHPS coats a surface of the lithium-stuffed garnet. Typically, during the operation of an energy storage device, lithium tends to plate out unevenly, or form lithium dendrites, onto surfaces with defects. Upon lithium dendrite formation, lithium also tends to cause energy storage device failures in the form of shorting. Applicants have unexpectedly observed that coating comprising A(LiBH₄)(1−A)(P₂S₅) wherein 0.05≤A≤0.95, provided herein remove or fill surface defects by coating the defects, thereby extending the lifetimes for energy storage devices. For example, in one embodiment, the LBHPS may be conformally bonded to the surface of the lithium-stuffed garnet. By way of further example, in one embodiment, the LBHPS may be bonded to defects in the lithium-stuffed garnet.

### Composition Dimensions

In some embodiments, the LBHPS composition may be a film (e.g., on a current collector such as copper metal or on an electrolyte such as lithium-stuffed garnet monoliths or thin films). For example, in one embodiment, the composition may be a thin film. In certain embodiments, the thin films set forth herein have a thickness greater than 10 nm and less than 30 μm. For example, in one embodiment, the thin films are less than 20 μm in thickness. By way of further example, in one embodiment, the thin films are less than 19 μm in thickness. By way of further example, in one embodiment, the thin films are less than 18 μm in thickness. By way of further example, in one embodiment, the thin films are less than 17 μm in thickness. By way of further example, in one embodiment, the thin films are less than 16 μm in thickness. By way of further example, in one embodiment, the thin films are less than 15 μm in thickness. By way of further example, in one embodiment, the thin films are less than 14 μm in thickness. By way of further example, in one embodiment, the thin films are less than 13 μm in thickness. By way of further example, in one embodiment, the thin films are less than 12 μm in thickness. By way of further example, in one embodiment, the thin films are less than 11 μm in thickness. By way of further example, in one embodiment, the thin films are less than 10 μm in thickness. By way of further example, in one embodiment, the thin films are less than 9 μm in thickness. By way of further example, in one embodiment, the thin films are less than 8 μm in thickness. By way of further example, in one embodiment, the thin films are less than 7 μm in thickness. By way of further example, in one embodiment, the thin films are less than 6 μm in thickness. By way of further example, in one embodiment, the thin films are less than 5 μm in thickness. By way of further example, in one embodiment, the thin films are less than 4 μm in thickness. By way of further example, in one embodiment, the thin films are less than 3 μm in thickness. By way of further example, in one embodiment, the thin films are less than 2 μm in thickness. By way of further example, in one embodiment, the thin films are less than 1 μm in thickness. By way of further example, in one embodiment, the thin films are at least 1 nm in thickness.

In some embodiments, the composition comprising A(LiBH₄)(1−A)(P₂S₅) wherein 0.05≤A≤0.95 may be a film (e.g., on a current collector such as copper metal or on an electrolyte such as lithium-stuffed garnet monoliths or thin films). For example, in one embodiment, the composition may be a thin film. In certain embodiments, the thin films set forth herein have a thickness greater than 10 nm and less than 30 μm. For example, in one embodiment, the thin films are less than 20 μm in thickness. By way of further example, in one embodiment, the thin films are less than 19 μm in thickness. By way of further example, in one embodiment, the thin films are less than 18 μm in thickness. By way of further example, in one embodiment, the thin films are less than 17 μm in thickness. By way of further example, in one embodiment, the thin films are less than 16 μm in thickness. By way of further example, in one embodiment, the thin films are less than 15 μm in thickness. By way of further example, in one embodiment, the thin films are less than 14 μm in thickness. By way of further example, in one embodiment, the thin films are less than 13 μm in thickness. By way of further example, in one embodiment, the thin films are less than 12 μm in thickness. By way of further example, in one embodiment, the thin films are less than 11 μm in thickness. By way of further example, in one embodiment, the thin films are less than 10 μm in thickness. By way of further example, in one embodiment, the thin films are less than 9 μm in thickness. By way of further example, in one embodiment, the thin films are less than 8 μm in thickness. By way of further example, in one embodiment, the thin films are less than 7 μm in thickness. By way of further example, in one embodiment, the thin films are less than 6 μm in thickness. By way of further example, in one embodiment, the thin films are less than 5 μm in thickness. By way of further example, in one embodiment, the thin films are less than 4 μm in thickness. By way of further example, in one embodiment, the thin films are less than 3 μm in thickness. By way of further example, in one embodiment, the thin films are less than 2 μm in thickness. By way of further example, in one embodiment, the thin films are less than 1 μm in thickness. By way of further example, in one embodiment, the thin films are at least 1 nm in thickness.

In some of these examples, including any of the foregoing, the films are 1 mm in length. In some other of these examples, the films are 5 mm in length. In yet other examples, the films are 10 mm in length. In still other examples, the films are 15 mm in length. In certain examples, the films are 25 mm in length. In other examples, the films are 30 mm in length. In some examples, the films are 35 mm in length. In some other examples, the films are 40 mm in length. In still other examples, the films are 45 mm in length. In certain examples, the films are 50 mm in length. In other examples, the films are 30 mm in length. In some examples, the films are 55 mm in length. In some other examples, the films are 60 mm in length. In yet other examples, the films are 65 mm in length. In still other examples, the films are 70 mm in length. In certain examples, the films are 75 mm in length. In other examples, the films are 80 mm in length. In some examples, the films are 85 mm in length. In some other examples, the films are 90 mm in length. In still other examples, the films are 95 mm in length. In certain examples, the films are 100 mm in length. In other examples, the films are 30 mm in length.

In some examples, the films are 1 cm in length. In some other examples, the films are 2 cm in length. In other examples, the films are 3 cm in length. In yet other examples, the films are 4 cm in length. In some examples, the films are 5 cm in length. In other examples, the films are 6 cm in length. In yet other examples, the films are 7 cm in length. In some other examples, the films are 8 cm in length. In yet other examples, the films are 9 cm in length. In still other examples, the films are 10 cm in length. In some examples, the films are 11 cm in length. In some other examples, the films are 12 cm in length. In other examples, the films are 13 cm in length. In yet other examples, the films are 14 cm in length. In some examples, the films are 15 cm in length. In other examples, the films are 16 cm in length. In yet other examples, the films are 17 cm in length. In some other examples, the films are 18 cm in length. In yet other examples, the films are 19 cm in length. In still other examples, the films are 20 cm in length. In some examples, the films are 21 cm in length. In some other examples, the films are 22 cm in length. In other examples, the films are 23 cm in length. In yet other examples, the films are 24 cm in length. In some examples, the films are 25 cm in length. In other examples, the films are 26 cm in length. In yet other examples, the films are 27 cm in length. In some other examples, the films are 28 cm in length. In yet other examples, the films are 29 cm in length. In still other examples, the films are 30 cm in length. In some examples, the films are 31 cm in length. In some other examples, the films are 32 cm in length. In other examples, the films are 33 cm in length. In yet other examples, the films are 34 cm in length. In some examples, the films are 35 cm in length. In other examples, the films are 36 cm in length. In yet other examples, the films are 37 cm in length. In some other examples, the films are 38 cm in length. In yet other examples, the films are 39 cm in length. In still other examples, the films are 40 cm in length. In some examples, the films are 41 cm in length. In some other examples, the films are 42 cm in length. In other examples, the films are 43 cm in length. In yet other examples, the films are 44 cm in length. In some examples, the films are 45 cm in length. In other examples, the films are 46 cm in length. In yet other examples, the films are 47 cm in length. In some other examples, the films are 48 cm in length. In yet other examples, the films are 49 cm in length. In still other examples, the films are 50 cm in length. In some examples, the films are 51 cm in length. In some other examples, the films are 52 cm in length. In other examples, the films are 53 cm in length. In yet other examples, the films are 54 cm in length. In some examples, the films are 55 cm in length. In other examples, the films are 56 cm in length. In yet other examples, the films are 57 cm in length. In some other examples, the films are 58 cm in length. In yet other examples, the films are 59 cm in length. In still other examples, the films are 60 cm in length. In some examples, the films are 61 cm in length. In some other examples, the films are 62 cm in length. In other examples, the films are 63 cm in length. In yet other examples, the films are 64 cm in length. In some examples, the films are 65 cm in length. In other examples, the films are 66 cm in length. In yet other examples, the films are 67 cm in length. In some other examples, the films are 68 cm in length. In yet other examples, the films are 69 cm in length. In still other examples, the films are 70 cm in length. In some examples, the films are 71 cm in length. In some other examples, the films are 72 cm in length. In other examples, the films are 73 cm in length. In yet other examples, the films are 74 cm in length. In some examples, the films are 75 cm in length. In other examples, the films are 76 cm in length. In yet other examples, the films are 77 cm in length. In some other examples, the films are 78 cm in length. In yet other examples, the films are 79 cm in length. In still other examples, the films are 80 cm in length. In some examples, the films are 81 cm in length. In some other examples, the films are 82 cm in length. In other examples, the films are 83 cm in length. In yet other examples, the films are 84 cm in length. In some examples, the films are 85 cm in length. In other examples, the films are 86 cm in length. In yet other examples, the films are 87 cm in length. In some other examples, the films are 88 cm in length. In yet other examples, the films are 89 cm in length. In still other examples, the films are 90 cm in length. In some examples, the films are 91 cm in length. In some other examples, the films are 92 cm in length. In other examples, the films are 93 cm in length. In yet other examples, the films are 94 cm in length. In some examples, the films are 95 cm in length. In other examples, the films are 96 cm in length. In yet other examples, the films are 97 cm in length. In some other examples, the films are 98 cm in length. In yet other examples, the films are 99 cm in length. In still other examples, the films are 100 cm in length. In some examples, the films are 101 cm in length. In some other examples, the films are 102 cm in length. In other examples, the films are 103 cm in length. In yet other examples, the films are 104 cm in length. In some examples, the films are 105 cm in length. In other examples, the films are 106 cm in length. In yet other examples, the films are 107 cm in length. In some other examples, the films are 108 cm in length. In yet other examples, the films are 109 cm in length. In still other examples, the films are 110 cm in length. In some examples, the films are 111 cm in length. In some other examples, the films are 112 cm in length. In other examples, the films are 113 cm in length. In yet other examples, the films are 114 cm in length. In some examples, the films are 115 cm in length. In other examples, the films are 116 cm in length. In yet other examples, the films are 117 cm in length. In some other examples, the films are 118 cm in length. In yet other examples, the films are 119 cm in length. In still other examples, the films are 120 cm in length.

In some examples, the garnet-based films are prepared as a monolith useful for a lithium secondary battery cell. In some of these cells, the form factor for the garnet-based film is a film with a top surface area of about 10 cm². In certain cells, the form factor for the garnet-based film with a top surface area of about 25 cm². In certain cells, the form factor for the garnet-based film with a top surface area of about 100 cm². In certain cells, the form factor for the garnet-based film with a top surface area of about 200 cm².

In some examples, the films set forth herein have a Young's Modulus of about 130-150 GPa. In some other examples, the films set forth herein have a Vicker's hardness of about 5-7 GPa. In some other examples, the films set forth herein have a fracture strength of greater than 300 MPa or greater than 400 MPa or greater than 500 MPa, or greater than 600 MPa, or greater than 700 MPa, or greater than 800 MPa, or greater than 900 MPa, or greater than 1 GPa. In some of these examples, the films include a lithium-stuffed garnet. In some of these examples, the films include a lithium-stuffed garnet coated with LBHPS.

In certain embodiments, the composition may be a thin film and include a porosity as determined by SEM for the thin film. For example, in one embodiment, the compositions set forth herein may have a porosity less than 5%. By way of further example, in one embodiment, the compositions set forth herein may have a porosity less than 6%. By way of further example, in one embodiment, the compositions set forth herein may have a porosity less than 7%. By way of further example, in one embodiment, the compositions set forth herein may have a porosity less than 8%. By way of further example, in one embodiment, the compositions set forth herein may have a porosity less than 4%. By way of further example, in one embodiment, the compositions set forth herein may have a porosity less than 3%. By way of further example, in one embodiment, the compositions set forth herein may have a porosity less than 2%. By way of further example, in one embodiment, the compositions set forth herein may have a porosity less than 1%. By way of further example, in one embodiment, the compositions set forth herein may have a porosity less than 0.5%.

In certain embodiments, the composition may be a thin film and include a porosity as determined by SEM for the thin film. For example, in one embodiment, the compositions set forth herein may have a porosity less than 5% by volume. By way of further example, in one embodiment, the compositions set forth herein may have a porosity less than 6% by volume. By way of further example, in one embodiment, the compositions set forth herein may have a porosity less than 7% by volume. By way of further example, in one embodiment, the compositions set forth herein may have a porosity less than 8% by volume. By way of further example, in one embodiment, the compositions set forth herein may have a porosity less than 4% by volume. By way of further example, in one embodiment, the compositions set forth herein may have a porosity less than 3% by volume. By way of further example, in one embodiment, the compositions set forth herein may have a porosity less than 2% by volume. By way of further example, in one embodiment, the compositions set forth herein may have a porosity less than 1% by volume. By way of further example, in one embodiment, the compositions set forth herein may have a porosity less than 0.5% by volume.

In certain embodiments, substrates having thin films deposited thereon may be prepared via dip coating. Applicants have unexpectedly noted that dip coating the substrate to express thin films improves the surface of the substrate. For example, in one embodiment, the surface of the substrate may have a smooth surface. Dip coatings may include a plurality of dips. For example, in one embodiment, a substrate may be dip coated 1 time. By way of further example, a substrate may be dip coated 2 times. By way of further example, a substrate may be dip coated 5 times. By way of further example, a substrate may be dip coated 10 times. By way of further example, a substrate may be dip coated 20 times.

Dip coating typically includes a withdrawal rate that affects the thickness of the coating. In certain embodiments, the withdrawal rate may include a range of 0.01 to 0.25 mm/min. For example, in one embodiment, the withdrawal rate is 0.05 mm/min. By way of further example, in one embodiment, the withdrawal rate is 0.1 mm/min. By way of further example, in one embodiment, the withdrawal rate is 0.15 mm/min. By way of further example, in one embodiment, the withdrawal rate is 0.2 mm/min. By way of further example, in one embodiment, the withdrawal rate is 0.25 mm/min. Withdrawal rate may be determined, for example, by measuring the distance of a substrate out of a molt per time.

In certain embodiments, the thin film coating thickness may be governed by the Landau-Levich equation shown below:

$$h = \frac{0.94 {( η U )}^{2 / 3}}{{{γ}_{L V}^{1 / 6} ( ρ g )}^{1 / 2}}$$

where h is the coating thickness, η is the viscosity, U is withdrawal rate or wall speed, γ_{LV} is the liquid-vapor surface tension, ρ is the density, and g is gravity. Coating thickness is largely determined by the withdrawal rate, solid content, and viscosity of the liquid. In certain embodiments, the thin film coating may not be governed by the Landau-Levich equation. For example, in one embodiment, a withdrawal rate of about 0.1 mm/min provides a film thickness of about 70 μm. By way of further example, in one embodiment, a withdrawal rate of <0.1 mm/min provides a film thickness of about 1 μm to about 10 μm. By way of further example, in one embodiment, a withdrawal rate of <0.1 mm/min and a retention time of about 5 min to about 10 min provides a film thickness of about 1 μm to about 10 μm.

In certain embodiments, the combination of multiple dips via dip coating produces a smooth film. For example, in one embodiment, 2-5 dips may be used. By way of further example, in one embodiment, 5-15 dips may be used. By way of further example, in one embodiment, 2-20 dips may be used. By way of further example, in one embodiment, 10-30 dips may be used.

For example, in one embodiment, dip coating at >4 mm/sec provides a smooth film. By way of further example, in one embodiment, dip coating at >4 mm/sec with a thermal equilibration time of about 5 s to about 20 s provides a smooth film. By way of further example, in one embodiment, dip coating at >4 mm/sec with a thermal equilibration time of about 5 s to about 20 s and dip cycling about 10 to about 30 times provides a smooth film. By way of further example, in one embodiment, dip coating at >4 mm/sec with a thermal equilibration time of about 5 s to about 20 s with dip cycling about 10 to about 30 times and a total retention time of about 200 s provides a smooth film. By way of further example, in one embodiment, dip coating at >4 mm/sec with a thermal equilibration time of about 5 s to about 20 s at 330-384° C. with dip cycling about 10 to about 30 times and a total retention time of about 6.7 min provides a smooth film.

In certain embodiments, the molten LBHPS is applied via spin coating. A spin coater with heating capability is used for this embodiment. Powder is first applied on the substrate to be coated. The spin coater is heated to or above the melting point of the LBHPS. After melting, the substrate is rotated at speed of 100-5000 rpm while heat is applied. It is to be understood that the spin speed may correlate strongly with the coating film thickness. After rotation stops, the 2^{nd} layer, which could be a solid-state cathode film, or another lithium ion conducting separator (which is the same or a different Li ion conductor than the first substrate) is laminated at a pressure of 10-2000 pounds per square inch (PSI). Heat is optionally applied. After cooling the laminate to room temperature, the substrate, LBHPS and top layer are bonded together very well and cannot be separated without breaking.

### Energy Storage Devices

In some embodiments, the disclosure herein sets forth energy storage devices 910, 1010, or 1110 including electrochemical cells, as described elsewhere herein. For example, in one embodiment, an electrochemical cell includes a positive electrode, a negative electrode and a solid state electrolyte having the composition as described any of the foregoing examples or embodiments, or any others set forth herein. By way of further example, in one embodiment, the electrochemical cell is a rechargeable battery.

### Battery Architectures

Referring again to FIG. 11, shown is another embodiment of an energy storage device or electrochemical cell 1110. This embodiment also includes a positive electrode or cathode 1120, an anode or lithium metal negative electrode 1140, a solid state conductor or solid separator 1130 positioned between the cathode 1120 and the anode 1140, and current collectors 1150 and 1160 corresponding to a cathode current collector and an anode current collector, respectively. In this embodiment, the solid separator 1130 may be configured as a coated garnet 1130A, also including a cathode directly contacting the separator and an anode directly contacting the separator further configured to electrically insulate the cathode from the anode, while still allowing ionic flow (e.g., lithium ions) between the cathode 1120 and the anode 1140 during operation of energy storage device 1110. In this embodiment, the anode directly contacts the separator 1130, where coating 1130B may coat one portion of the solid separator 1130. Again, as in FIG. 10, cathode 1020 also includes a catholyte 1070 positioned between solid separator 1030 and cathode 1020. In certain embodiments, catholyte 1070 may penetrate cathode 1020 while still being positioned between cathode 1020 and solid separator 1030, as in FIG. 10A. Further, in this embodiment, the anode directly contacting the separator 1030B includes the composition(s) as described elsewhere herein. In another embodiment, the anode directly contacting the separator 1030B may be less than 20 μm thick.

In another embodiment, the solid separator 1030 may be configured as a coated garnet 1030A, also including a cathode-interfacing separator and/or an anode-interfacing separator further configured to electrically insulate the cathode from the anode, while still allowing ionic flow (e.g., lithium ions) between the cathode 1020 and the anode 1040 during operation of energy storage device 1010. For example, in certain embodiments, the cathode-interfacing separator may not directly contact the separator. By way of further example, in certain embodiments, the anode-interfacing separator may not directly contact the separator.

### Methods of Making the Materials Described Herein

In one embodiment, disclosed herein is a method of making the composition A.(LiBH₄).1−A.(P₂S₅) wherein 0.05≤A≤0.95.

In one embodiment, disclosed herein is a method for making a thin film including the A(LiBH₄)(1−A)(P₂S₅) composition, the method including a) providing a LBHPS powder, b) making a slurry using solvents and binders, c) casting the slurry onto a solid-state cathode, d) optionally compressing or calendaring the solid-state electrolyte and the solid-state cathode, and e) singulating parts to place into a full cell. In another embodiment, disclosed herein is a method for making a thin film including the A(LiBH₄)(1−A)(P₂S₅) composition, the method including a) providing a LBHPS powder, b) making a slurry using solvents and binders, c) casting the slurry onto a solid-state separator to form a bilayer, d) optionally compressing or calendaring the bilayer, and e) laminating or stacking the bilayer with a solid-state cathode to form a full cell. In another embodiment, also disclosed herein are electrochemical devices which incorporate these materials. For example, disclosed herein is an electrochemical cell having a lithium metal negative electrode; a solid separator; and a positive electrode with a bonding layer of LBHPS between the solid-state separator and the positive cathode.

In certain embodiments, disclosed herein is a method for making a thin film including the A(LiBH₄)(1−A)(P₂S₅) composition, the method including a) preparing a A(LiBH₄)(1−A)(P₂S₅) wherein 0.05≤A≤0.95, b) providing a slurry of A(LiBH₄)(1−A)(P₂S₅) wherein 0.05≤A≤0.95; casting the slurry on a substrate; c) pressing the A(LiBH₄)(1−A)(P₂S₅) wherein 0.05≤A≤0.95 and the substrate at 10-2000 PSI and at 10-150° C.

In certain embodiments, the solvent for making the slurry is selected from toluene; toluene and ethylene alpha-olefin copolymer; hexane; hexane and ethylene alpha-olefin copolymer, and tributylamine.

In some examples, the substrate in the method may be a metal selected from the group consisting of copper and nickel. By way of further example, in one embodiment, the substrate in the method may be copper. By way of further example, in one embodiment, the substrate in the method may be nickel. By way of further example, in one embodiment, the substrate in the method may be a foil. In some examples, the substrate is a solid-state separator. In some examples, the substrate is a solid-state cathode.

In some examples, solid-state cathode is made of NMC, LSPSCl and binder. In some examples, the solid-state cathode is made of NMC, LSPSCl and ethylene alpha-olefin copolymer and carbon. In some examples, the solid-state cathode is made of NCA, LSPSCl and ethylene alpha-olefin copolymer. In some examples, the solid-state cathode is made of NCA, LSTPS, ethylene alpha-olefin copolymer and carbon. In some examples, the solid-state cathode comprises positive active material and a catholyte. In some examples, the solid-state cathode comprises positive active material, binder and a catholyte. In some examples, the solid-state cathode comprises positive active material, conductive additive and a catholyte. In some examples, the solid-state cathode comprises positive active material, binder, conductive additive and a catholyte.

In certain embodiments, the positive active material may be selected from CuF₂, FeF₃, FeF₂, FeOF, NiF₂, NCA, NMC, LNMO, LiNiPO₄, LiCoPO₄, and the like. In certain embodiments, the catholyte may be selected from LSTPS, LGPS, LSPS, LTPS, LSPSC, LATS, LSS, LBS, LTS, SLOPS, SLOBS, and sulfide ion conductors. In certain embodiments, the binder may be selected from SBR, PVDF, PVDF-HFP, ethylene alpha-olefin copolymer, polyolefins. In certain embodiments, the conductive additive may be selected from SuperP, Kynar, acetylene black, ketjen black, C65, VGCF, carbon nanofibers, carbon nanotubes, and the like.

In certain embodiments, the LBHPS powder is a stable composition including A(LiBH₄)(1−A)(P₂S₅) composition, the method including a) preparing a A(LiBH₄)(1−A)(P₂S₅) wherein 0.05≤A≤0.95 having a XRD pattern characterized by peaks at approximately 14.4°, 15.0°, 17.4°, 19.1°, 29.2°, 30.1°, 33.3°, 38.6°, 43.5°, 43.8°, 46.5°, 51.0°, and 53.4° 2θ. For example, in one embodiment, provided is a stable composition including A(LiBH₄)(1-A)(P₂S₅) wherein A is 0.9 having a XRD pattern characterized by peaks at approximately 14.4°, 15.0°, 17.4°, 19.1°, 29.2°, 30.1°, 33.3°, 38.6°, 43.5°, 43.8°, 46.5°, 51.0°, and 53.4°. 2θ.

In certain embodiments, disclosed herein is a method for making a thin film including the A(LiBH₄)(1−A)(P₂S₅) wherein 0.05≤A≤0.95 composition, the method including a) preparing a A(LiBH₄)(1−A)(P₂S₅) wherein 0.05≤A≤0.95 composition material, b) providing a molten mixture, wherein the mixture includes A.(LiBH₄).1−A.(P₂S₅) wherein 0.05≤A≤0.95; c) dip-coating a substrate in the molten mixture; d) withdrawing the substrate; and e) cooling the substrate to room temperature. In some examples, the substrate is a current collector. In some examples, the substrate is a solid electrolyte. In some examples, the substrate is a lithium-stuffed garnet.

In certain embodiments, the thin films of LBHPS set forth from the method herein have a thickness greater than 10 nm and less than 30 μm. For example, in one embodiment, the thin films set forth from the method are less than 20 μm in thickness. By way of further example, in one embodiment, the thin films set forth from the method are less than 19 μm in thickness. By way of further example, in one embodiment, the thin films set forth from the method are less than 18 μm in thickness. By way of further example, in one embodiment, the thin films set forth from the method are less than 17 μm in thickness. By way of further example, in one embodiment, the thin films set forth from the method are less than 16 μm in thickness. By way of further example, in one embodiment, the thin films set forth from the method are less than 15 μm in thickness. By way of further example, in one embodiment, the thin films set forth from the method are less than 14 μm in thickness. By way of further example, in one embodiment, the thin films set forth from the method are less than 13 μm in thickness. By way of further example, in one embodiment, the thin films set forth from the method are less than 12 μm in thickness. By way of further example, in one embodiment, the thin films set forth from the method are less than 11 μm in thickness. By way of further example, in one embodiment, the thin films set forth from the method are less than 10 μm in thickness. By way of further example, in one embodiment, the thin films set forth from the method are less than 9 μm in thickness. By way of further example, in one embodiment, the thin films set forth from the method are less than 8 μm in thickness. By way of further example, in one embodiment, the thin films set forth from the method are less than 7 μm in thickness. By way of further example, in one embodiment, the thin films set forth from the method are less than 6 μm in thickness. By way of further example, in one embodiment, the thin films set forth from the method are less than 5 μm in thickness. By way of further example, in one embodiment, the thin films set forth from the method are less than 4 μm in thickness. By way of further example, in one embodiment, the thin films set forth from the method are less than 3 μm in thickness. By way of further example, in one embodiment, the thin films set forth from the method are less than 2 μm in thickness. By way of further example, in one embodiment, the thin films set forth from the method are less than 1 μm in thickness. In certain embodiments, the LBHPS material may penetrate pores of the separator and may not be itself distinguishable as a separate layer.

In certain embodiments, the method may impart an ionic conductivity beneficial to the operation of the energy storage device 910, 1010, or 1100. For example, ionic conductivity may be for ions such as lithium. By way of further example, in one embodiment, the method may impart a lithium ion conductivity greater than 1×10⁻⁷ S/cm at 60° C. By way of further example, in one embodiment, the method may impart a lithium ion conductivity greater than 1×10⁻⁶ S/cm at 60° C. By way of further example, in one embodiment, the method may impart a lithium ion conductivity greater than 1×10⁻⁵ S/cm at 60° C. By way of further example, in one embodiment, the method may impart a lithium ion conductivity greater than 1×10⁻⁴ S/cm at 60° C. By way of further example, in one embodiment, the method may impart a lithium ion conductivity greater than 8×10⁴ S/cm at 60° C. Ion conductivity may be determined, for example, indirectly from the impedance in ASR measurements described elsewhere herein.

In certain embodiments, the substrate in the method may be a solid separator-electrolyte for a lithium battery. For example, in one embodiment, the substrate in the method may be a solid separator-electrolyte garnet for a lithium battery. By way of further example, in one embodiment, the substrate in the method may be a metal selected from the group consisting of copper and nickel. By way of further example, in one embodiment, the substrate in the method may be copper. By way of further example, in one embodiment, the substrate in the method may be nickel. By way of further example, in one embodiment, the substrate in the method may be a foil. By way of further example, in one embodiment, the substrate in the method may be a LPSI. By way of further example, in one embodiment, the substrate in the method may be a LPSI composite.

In certain embodiments, provided herein is a composite having a lithium-stuffed garnet and an LBHPS, where the LBHPS fills at least 90% of the through-pores and/or surface pores of the lithium-stuffed garnet, and where the LBHPS may be a composition having A(LiBH₄)(1−A)(P₂S₅) wherein 0.05≤A≤0.95. In certain embodiments, provided herein is a composite having a lithium-stuffed garnet and an LBHPS, where the LBHPS fills at least 95% of the through-pores and/or surface pores of the lithium-stuffed garnet, and where the LBHPS may be a composition having A(LiBH₄)(1−A)(P₂S₅) wherein 0.05≤A≤0.95.

In certain embodiments, provided herein is a composite having a lithium-stuffed garnet and an LBHPS, where the LBHPS fills at least 95% of the through-pores and/or surface pores of the lithium-stuffed garnet, and where the LBHPS may be a composition having A(LiBH₄)(1−A)(P₂S₅) wherein 0.05≤A≤0.95.

In certain embodiments, provided herein is a composite having a lithium-stuffed garnet and an LBHPS, where the LBHPS fills at least 90% of the through-pores and/or surface pores of the lithium-stuffed garnet, and where the LBHPS may be a composition having A(LiBH₄)(1−A)(P₂S₅) wherein 0.05≤A≤0.95.

In certain embodiments, provided herein is a composite having a lithium-stuffed garnet and an LBHPS, where the LBHPS fills at least 91% of the through-pores and/or surface pores of the lithium-stuffed garnet, and where the LBHPS may be a composition having A(LiBH₄)(1−A)(P₂S₅) wherein 0.05≤A≤0.95.

In certain embodiments, provided herein is a composite having a lithium-stuffed garnet and an LBHPS, where the LBHPS fills at least 92% of the through-pores and/or surface pores of the lithium-stuffed garnet, and where the LBHPS may be a composition having A(LiBH₄)(1−A)(P₂S₅) wherein 0.05≤A≤0.95.

In certain embodiments, provided herein is a composite having a lithium-stuffed garnet and an LBHPS, where the LBHPS fills at least 93% of the through-pores and/or surface pores of the lithium-stuffed garnet, and where the LBHPS may be a composition having A(LiBH₄)(1−A)(P₂S₅) wherein 0.05≤A≤0.95.

In certain embodiments, provided herein is a composite having a lithium-stuffed garnet and an LBHPS, where the LBHPS fills at least 94% of the through-pores and/or surface pores of the lithium-stuffed garnet, and where the LBHPS may be a composition having A(LiBH₄)(1−A)(P₂S₅) wherein 0.05≤A≤0.95.

In certain embodiments, provided herein is a composite having a lithium-stuffed garnet and an LBHPS, where the LBHPS fills at least 95% of the through-pores and/or surface pores of the lithium-stuffed garnet, and where the LBHPS may be a composition having A(LiBH₄)(1−A)(P₂S₅) wherein 0.05≤A≤0.95.

In certain embodiments, provided herein is a composite having a lithium-stuffed garnet and an LBHPS, where the LBHPS fills at least 96% of the through-pores and/or surface pores of the lithium-stuffed garnet, and where the LBHPS may be a composition having A(LiBH₄)(1−A)(P₂S₅) wherein 0.05≤A≤0.95.

In certain embodiments, provided herein is a composite having a lithium-stuffed garnet and an LBHPS, where the LBHPS fills at least 97% of the through-pores and/or surface pores of the lithium-stuffed garnet, and where the LBHPS may be a composition having A(LiBH₄)(1−A)(P₂S₅) wherein 0.05≤A≤0.95.

In certain embodiments, provided herein is a composite having a lithium-stuffed garnet and an LBHPS, where the LBHPS fills at least 98% of the through-pores and/or surface pores of the lithium-stuffed garnet, and where the LBHPS may be a composition having A(LiBH₄)(1−A)(P₂S₅) wherein 0.05≤A≤0.95.

In certain embodiments, provided herein is a composite having a lithium-stuffed garnet and an LBHPS, where the LBHPS fills at least 99% of the through-pores and/or surface pores of the lithium-stuffed garnet, and where the LBHPS may be a composition having A(LiBH₄)(1−A)(P₂S₅) wherein 0.05≤A≤0.95.

In certain embodiments, provided herein is a composition having an LBHPS coating on a roughened lithium-stuffed garnet where the LBHPS may be a composition having A(LiBH₄)(1−A)(P₂S₅) wherein 0.05≤A≤0.95.

In certain embodiments, provided herein is a composition having an LBHPS on a curved lithium-stuffed garnet where the LBHPS may be a composition having A(LiBH₄)(1-A)(P₂S₅) wherein 0.05≤A≤0.95.

In certain embodiments, provided herein is a composition having an LBHPS coating on a corrugated lithium-stuffed garnet where the LBHPS may be a composition having A(LiBH₄)(1−A)(P₂S₅) wherein 0.05≤A≤0.95.

In certain embodiments, provided herein is a composition having an LBHPS interdigitated within a lithium-stuffed garnet where the LBHPS may be a composition having A(LiBH₄)(1−A)(P₂S₅) wherein 0.05≤A≤0.95.

In certain embodiments, provided herein is a method for coating a lithium ion conducting separator electrolyte, the method including: a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. For example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.959 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator.

In certain embodiments, provided herein is a method for coating a lithium ion conducting separator electrolyte, the method including: a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. For example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A. LiBH₄).1−A.(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator. By way of further example, in one embodiment, the method for coating a lithium ion conducting separator electrolyte includes a) providing the separator electrolyte; and b) pressing a composition of A(LiBH₄)(1−A)(P₂S₅) wherein 0.05≤A≤0.95 at a temperature between 100-280° C. at a pressure of 10-2000 PSI on at least one surface of the separator.

In certain embodiments, the temperature in the method is below the melting point (Tₘ) of the separator, and is about 0.8 Tₘ, where Tₘ is expressed in Kelvin (K).

In certain embodiments, the method further includes c) holding the pressure between the composition and the separator for 1-300 min.

In certain embodiments, the method further includes d) cooling the coated lithium ion conducting separator electrolyte under pressure for 10-1000 min.

In certain embodiments, the method further includes d) cooling the coated lithium ion conducting separator electrolyte under pressure for 10-1000 min to room temperature.

In certain embodiments, provided is a method for coating a lithium ion conducting separator electrolyte, the method including a) providing a lithium-stable separator electrolyte; b) providing a mixture of a solvent and A(LiBH₄)(1−A)(P₂S₅) wherein 0.05≤A≤0.95; and c) depositing the mixture on the separator by spray coating, spin coating, dip coating, slot die coating, gravure coating, or microgravure coating. For example, in one embodiment, provided is a method for coating a lithium ion conducting separator electrolyte, the method including a) providing a lithium-stable separator electrolyte; b) providing a mixture of a solvent and a composition comprising A(LiBH₄)(1−A)(P₂S₅) wherein 0.05≤A≤0.95; and c) depositing the mixture on the separator by spray coating. By way of further example, in one embodiment, provided is a method for coating a lithium ion conducting separator electrolyte, the method including a) providing a lithium-stable separator electrolyte; b) providing a mixture of a solvent and composition comprising A(LiBH₄)(1−A)(P₂S₅) wherein 0.05≤A≤0.95; and c) depositing the mixture on the separator by spin coating. By way of further example, in one embodiment, provided is a method for coating a lithium ion conducting separator electrolyte, the method including a) providing a lithium-stable separator electrolyte; b) providing a mixture of a solvent and composition comprising A(LiBH₄)(1−A)(P₂S₅) wherein 0.05≤A≤0.95; and c) depositing the mixture on the separator by dip coating. By way of further example, in one embodiment, provided is a method for coating a lithium ion conducting separator electrolyte, the method including a) providing a lithium-stable separator electrolyte; b) providing a mixture of a solvent and composition comprising A(LiBH₄)(1−A)(P₂S₅) wherein 0.05≤A≤0.95; and c) depositing the mixture on the separator by slot die coating. By way of further example, in one embodiment, provided is a method for coating a lithium ion conducting separator electrolyte, the method including a) providing a lithium-stable separator electrolyte; b) providing a mixture of a solvent and composition comprising A(LiBH₄)(1−A)(P₂S₅) wherein 0.05≤A≤0.95; and c) depositing the mixture on the separator by gravure coating. By way of further example, in one embodiment, provided is a method for coating a lithium ion conducting separator electrolyte, the method including a) providing a lithium-stable separator electrolyte; b) providing a mixture of a solvent and an composition comprising A(LiBH₄)(1−A)(P₂S₅) wherein 0.05≤A≤0.95; and c) depositing the mixture on the separator by microgravure coating.

In certain embodiments, the solvent in the method is selected from the group consisting of tetrahydrofuran, diethyl ether, methanol, and ethanol. For example, in one embodiment, the solvent in the method is tetrahydrofuran. By way of further example, in one embodiment, the solvent in the method is diethyl ether. By way of further example, in one embodiment, the solvent in the method is ethanol. By way of further example, in one embodiment, the solvent in the method is methanol.

In certain embodiments, the lithium-stable separator in the method has defects on the surface.

### EXAMPLES

In the examples described herein, the subscript values in the product lithium-stuffed garnets formed by the methods herein represent elemental molar ratios of the precursor chemicals used to make the claimed composition.

Electron microscopy was performed in a FEI Quanta SEM, a Helios 600i, or a Helios 660 FIB-SEM, though equivalent tools may be substituted. XRD was performed in a Bruker D8 Advance ECO or a Rigaku Miniflex 2. Viscosity is measured using Rheometer under the shear rate of 100 s⁻¹. EIS was performed with a Biologic VMP3, VSP, VSP-300, SP-150, or SP-200.

### Example 1—LBHPS Powder Synthesis

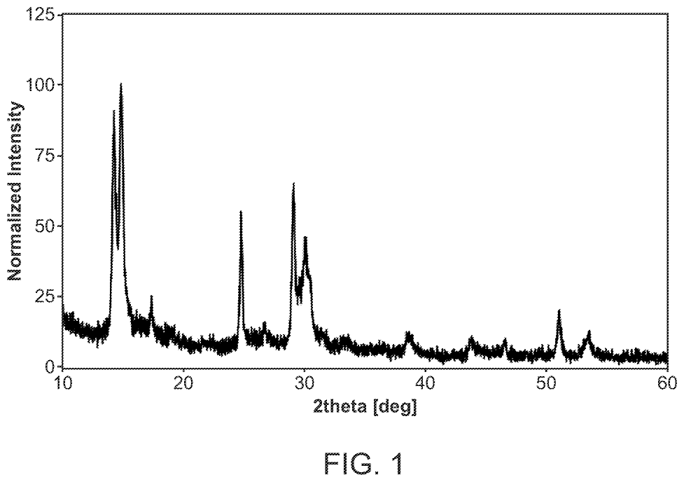

LBHPS powder for which the XRD spectra is shown in FIG. 1 was prepared by using 0.9 moles of lithium borohydride (LiBH₄) and 0.1 moles of phosphorous pentasulfide (P₂S₅). The LiBH₄ and P₂S₅ were co-milled together in a planetary mill with zirconia media. The post-milling powder was then calcined at 150° C. for 2 hours to achieve a high-conductivity phase. An XRD spectra of this high-conductivity phase is presented in FIG. 1 wherein there is 0.9 LiBH₄ and 0.1 P₂S₅ molar ratio.

### Example 2—Slurry Formation—Generally

Following the powder synthesis in Example 1, the resulting powder was cast as follows. The powder was mixed in a flacktek cup with either 1) a dispersing solvent or 2) a dispersing solvent and binder. The following solvents and/or binders were tested as being compatible: toluene, toluene+ethylene alpha-olefin copolymer, hexane, hexane+ethylene alpha-olefin copolymer, and tributylamine. Three 15 mm stainless steel balls were added to the mixture, which was followed by vigorous mixing using a flacktek. The procedure called for three 5-minute steps operated at 3000 rpm. The slurry was then inspected in between each of three flacktek steps to ensure solvent had been retained and viscosity was in the range of 100-5000 mPa·s.

### Example 3—LBHPS Slurry Formation with Ethylene Alpha-Olefin Copolymer and Toluene

1.5 g of the resulting powder from Example 1 was mixed in a 50 mL flacktek cup with 0.72 g of ethylene alpha-olefin copolymer binder and 1.5 g of toluene solvent. Three 15 mm stainless steel balls were added to the mixture, which was followed by vigorous mixing in flacktek for three 5-minute steps at 3000 rpm. Additional 0.75 g of toluene was added for desired viscosity.

### Example 4—LBHPS Slurry Formation with Ethylene Alpha-Olefin Copolymer and Hexane

1.5 g of the resulting powder from Example 1 was mixed in a 50 mL flacktek cup with 0.8 g of ethylene alpha-olefin copolymer binder and 1.47 g of hexane. Three 15 mm stainless steel balls were added to the mixture, which was followed by vigorous mixing in flacktek for three 5-minute steps at 3000 rpm. Additional 3 g of hexane was added for desired viscosity.

### Example 5—LBHPS Slurry Formation with Hexane

3 g of the resulting powder from Example 1 was mixed in a 50 mL flacktek cup with 3 g of hexane. Three 15 mm stainless steel balls were added to the mixture, which was followed by vigorous mixing in flacktek for three 5-minute steps at 3000 rpm. No additional solvent was needed for desired viscosity.

### Example 6—LBHPS Slurry Formation with Tri-Butylamine

3 g of the resulting powder from Example 1 was mixed in a 50 mL flacktek cup with 3 g of tri-butylamine. Three 15 mm stainless steel balls were added to the mixture, which was followed by vigorous mixing in flacktek for three 5-minute steps at 3000 rpm. No additional solvent was needed for desired viscosity.

### Example 7—LBHPS Slurry Casting on a Solid-State Cathode

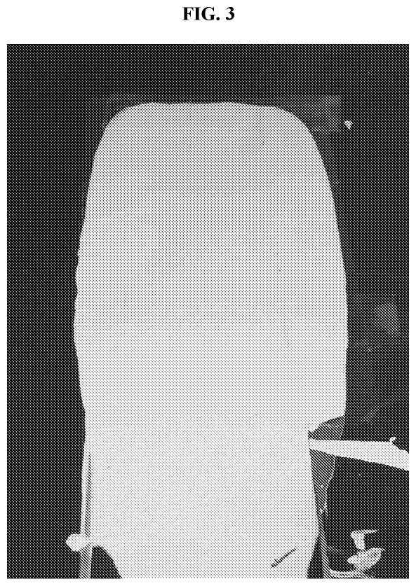

The resulting slurry from Example 3 with 35% solid loading was then casted onto a solid-state sulfide cathode made of LSTPS by a doctor blade with gap size 500 μm to form a bilayer. The product of this is demonstrated in FIG. 3 where the white material on the surface is LBHPS and a calendered cathode can be found beneath.

### Example 8—Calendering

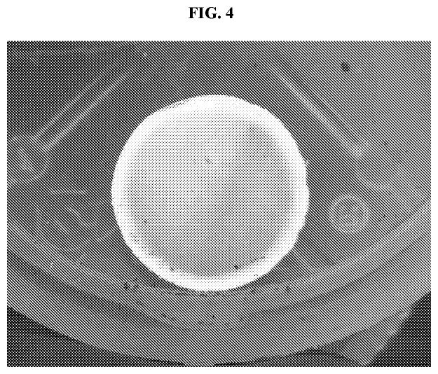

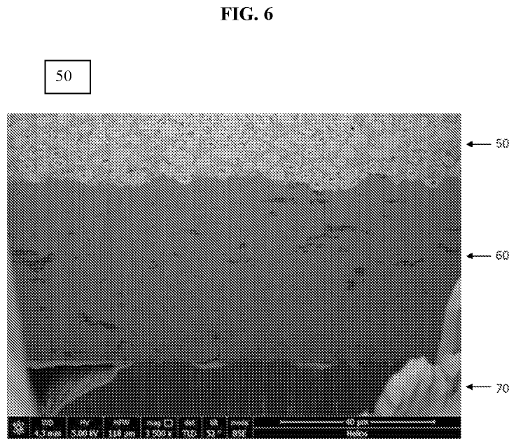

This cast from Example 6 was pressed at 100 kPSI, and then punched into 8 mm discs as shown in FIG. 4. FIG. 6 shows the Fib cross-section of the LBHPS bonding layer calendered on top of solid-state cathode (80 wt % NCA, 18 wt % LSTPS, 1.5 wt % binder). Dark regions in the densified LBHPS bonding layer are Li₂S secondary phases. This 8 mm disc was subjected to additional densification via a uniaxial press to further decrease bulk and interfacial impedances.

### Example 9—Full Cell Construction

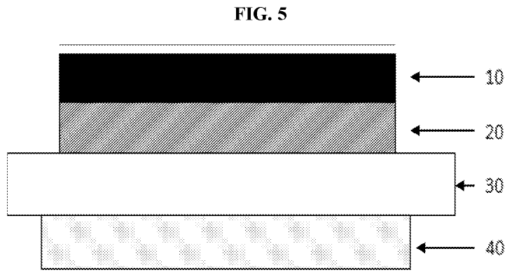

A full cell was prepared as shown in FIG. 5 using the calendered disc from Example 7. The LBHPS bonding layer was 100 μm in thickness and the solid-state cathode (⅔ NCA, ⅓ LSTPS catholyte, <5% dow chemical EG8200/Carbon 1.5 wt %/0.5% wt %) was 150 μm in thickness from Example 7. The oxide separator film of Li-stuffed garnet doped with aluminum was 80 μm thick. The lithium metal anode was 30 μm.

### Example 10—GITT Testing of Full Cell with LBHPS Bonding Layer Between the Solid-State Cathode (SSC) and the Lithium Stuffed Garnet Film Electrolyte Separator

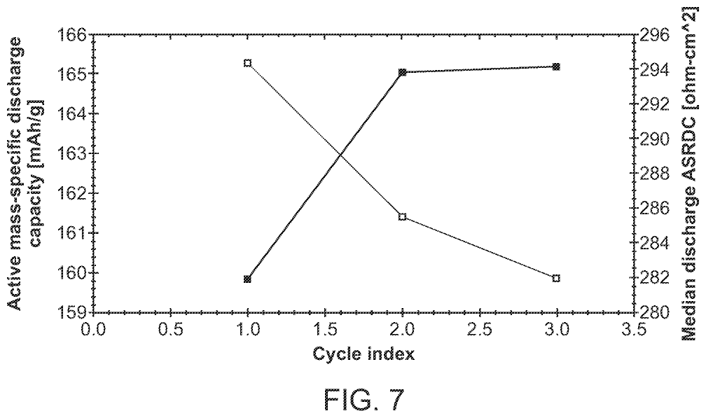

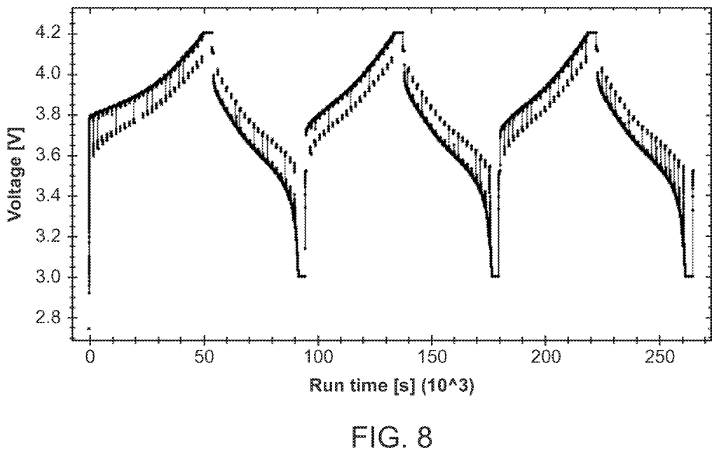

These discs were then utilized in a full cell architecture as described in FIG. 5 to bond a solid-state separator to a solid-state cathode. The full cell was then cycled with an Arbin battery cycler at C/10 to obtain electrical data as shown in FIGS. 7 and 8. The full cell prepared in Example 8 was cycled in a Galvanostatic intermittent titration technique (GITT) protocol at 45° C. Three cycles of charge and discharge GITT are shown in FIG. 8, which plots voltage versus time during the first three cycles.

In this Example, the ASRdc increase in electrochemical cells stored at 4.6V and 45° C. was monitored for four weeks. Herein, ASRdc is the Area-specific resistance (area specific resistance), which is determined by measuring the difference in voltage from the end of a 30 minute current pulse to a steady state value after 10 minutes. This means that ASR was determined by measuring a voltage change and calculating ASR by the equation, ASR=ΔV/j where ΔV is the voltage change after a current pulse in a GITT (Galvanostatic intermittent titration technique) test and j is the current density applied to the cell in the GITT test.

What is claimed is:

1. A composition comprising A(LiBH₄)(1−A)(P₂S₅), wherein 0.05≤A≤0.95.

2. The composition of claim 1, wherein 0.5<A<0.95.

3. The composition of claim 1 or 2, wherein A is 0.85, 0.9, or 9.95.

4. The composition of claim 1, 2, or 3, wherein the composition comprises 0.9(LiBH₄)0.1(P₂S₅).

5. The composition of any one of claims 1-4, wherein the composition is amorphous.

6. The composition of any one of claims 1-4, wherein the composition is semi-crystalline.

7. The composition of any one of claims 1-4, wherein the composition is polycrystalline.

8. The composition of any one of claims 1-7, wherein the composition is a thin film.

9. The composition of claim 8, wherein the thin film has a thickness of about 1 μm-200 μm.

10. The composition of claim 9, wherein the thickness is about 10 μm-100 μm.

11. The composition of any one of claims 1-7, wherein the composition is a monolith.

12. The composition of any one of claims 1-7, wherein the composition is a pressed pellet.

13. The composition of claim 12, wherein the pellet has a thickness of about 1 mm-100 mm.

14. The composition of any one of claims 5-13, wherein the composition has porosity of <5% by volume.

15. The composition of claim 14, wherein the porosity is less than 0.5% volume.

16. The composition of any one of claims 1-15, further comprising an oxide, a sulfide, a sulfide-halide, or a combination thereof.

17. The composition of any one of claims 1-15, further comprising an electrolyte.

18. The composition of claim 16, wherein the oxide is a lithium-stuffed garnet characterized by the formula LiₓLa_{y}Zr_{z}Oₜ.qAl₂O₃, wherein 4<x<10, 1<y<4, 1<z<3, 6<t<14, 0≤q≤1.

19. The composition of claim 16, wherein the oxide is a lithium-stuffed garnet doped with Nb, Ga, and/or Ta.

20. The composition of claim 16, wherein the oxide is a lithium-stuffed garnet characterized by the formula LiₐLa_{b}Zr_{c}Al_{d}Me″ₑO_{f}, wherein 5<a<8.5; 2<b<4; 0≤c≤2.5; 0≤d<2; 0≤e<2, and 10<f<13 and Me″ is a metal selected from the group consisting of Nb, Ga, Ta, and combinations thereof.

21. The composition of claim 16, wherein the sulfide or sulfide-halide is selected from LSS, SLOPS, LSTPS, LSTPSCl, SLOBS, LATS, or LPS+X, wherein X is selected from the group consisting of Cl, I, and Br.

22. The composition of claim 16, wherein the sulfide or sulfide-halide is selected from LSS, SLOPS, LSTPS, SLOBS, LATS, or LPS+X, wherein X is selected from the group consisting of Cl, I, and Br.

23. The composition of claim 22, wherein the LPS+X is LPSI.

24. The composition of claim 16, wherein the oxide is a lithium-stuffed garnet oxide characterized by the formula LiᵤLaᵥZrₓO_{y}.zAl₂O₃, wherein
u is a rational number from 4 to 8;
v is a rational number from 2 to 4;
x is a rational number from 1 to 3;
y is a rational number from 10 to 14; and
z is a rational number from 0.05 to 1;
wherein u, v, x, y, and z are selected so that the lithium-stuffed garnet oxide is charge neutral.

25. The composition of claim 16, wherein the sulfide is a lithium sulfide characterized by one of the following formula:
LiₐSi_{b}Sn_{c}P_{d}SₑO_{f}, wherein 2≤a≤8, 0≤b≤1, 0≤c≤1, b+c=1, 0.5≤d≤2.5, 4≤e≤12, and 0<f≤10;
LiₐSi_{b}P_{c}S_{d}Xₑ, wherein 8<a<12, 1<b<3, 1<c<3, 8<d<14, and 0<e<1, wherein X is F, Cl, Br, or I;
Li_{g}AsₕSnⱼSₖOₗ, wherein 2≤g≤6, 0≤h≤1, 0≤j≤1, 2≤k≤6, and 0≤1≤10;
LiₘPₙSₚI_{q}, wherein 2≤m≤6, 0≤n≤1, 0≤p≤1, 2≤q≤6;
a mixture of (Li₂S):(P₂S₅) having a molar ratio of Li₂S:P₂S₅ from about 10:1 to about 6:4 and LiI, wherein the ratio of [(Li₂S):(P₂S₅)]:LiI is from 95:5 to 50:50;
LPS+X, wherein X is selected from Cl, I, or Br;
vLi₂S+wP₂S₅+yLiX;
vLi₂S+wSiS₂+yLiX; or
vLi₂S+wB₂S₃+yLiX.

26. The composition of claim 16 or 25, wherein the composition comprises:
a mixture of LiI and Al₂O₃;
Li₃N;
a mixture of LiBH₄ and LiX wherein X is selected from Cl, I, or Br; or
vLiBH₄+wLiX+yLiNH₂, wherein X is selected from Cl, I, or Br; and
wherein coefficients v, w, and y are rational numbers from 0 to 1.

27. The composition of claim 17, wherein the electrolyte is selected from the group consisting of:
LIRAP;
LATP;
LAGP;
a mixture of LiI and Al₂O₃;
Li₃N;
a mixture of LiBH₄ and LiX wherein X is selected from Cl, I, or Br; and
vLiBH₄+wLiX+yLiNH₂, wherein X is selected from Cl, I, or Br;
wherein coefficients v, w, and y are rational numbers from 0 to 1.

28. The composition of claim 16, wherein the oxide is a lithium-stuffed garnet oxide characterized by the formula LiᵤLaᵥZrₓO_{y}.zTa₂O₅, wherein
u is a rational number from 4 to 10;
v is a rational number from 2 to 4;
x is a rational number from 1 to 3;
y is a rational number from 10 to 14; and
z is a rational number from 0 to 1;
wherein u, v, x, y, and z are selected so that the lithium-stuffed garnet oxide is charge neutral.

29. The composition of claim 16, wherein the oxide is a lithium-stuffed garnet oxide characterized by the formula LiᵤLaᵥZrₓO_{y}.zNb₂O₅, wherein
u is a rational number from 4 to 10;
v is a rational number from 2 to 4;
x is a rational number from 1 to 3;
y is a rational number from 10 to 14; and
z is a rational number from 0 to 1;
wherein u, v, x, y, and z are selected so that the lithium-stuffed garnet oxide is charge neutral.

30. The composition of claim 16, wherein the oxide is a lithium-stuffed garnet oxide characterized by the formula LiᵤLaᵥZrₓO_{y}.zGa₂O₃, wherein
u is a rational number from 4 to 10;
v is a rational number from 2 to 4;
x is a rational number from 1 to 3;
y is a rational number from 10 to 14; and
z is a rational number from 0 to 1;
wherein u, v, x, y, and z are selected so that the lithium-stuffed garnet oxide is charge neutral.

31. The composition of claim 16, wherein the oxide is a lithium-stuffed garnet oxide characterized by the formula LiᵤLaᵥZrₓO_{y}.zTa₂O₅.bAl₂O₃, wherein
u is a rational number from 4 to 10;
v is a rational number from 2 to 4;
x is a rational number from 1 to 3;
y is a rational number from 10 to 14;
z is a rational number from 0 to 1;
b is a rational number from 0 to 1;
wherein z+b≤1; and
u, v, x, y, and z are selected so that the lithium-stuffed garnet oxide is charge neutral.

32. The composition of claim 16, wherein the oxide is a lithium-stuffed garnet oxide characterized by the formula LiᵤLaᵥZrₓO_{y}.zNb₂O₅.bAl₂O₃, wherein
u is a rational number from 4 to 10;
v is a rational number from 2 to 4;
x is a rational number from 1 to 3;
y is a rational number from 10 to 14;
z is a rational number from 0 to 1;
b is a rational number from 0 to 1;
wherein z+b≤1; and
u, v, x, y, and z are selected so that the lithium-stuffed garnet oxide is charge neutral.

33. The composition of claim 16, wherein the oxide is:
a lithium-stuffed garnet oxide characterized by the formula LiᵤLaᵥZrₓO_{y}.zGa₂O₃.bAl₂O₃, wherein
u is a rational number from 4 to 10;
v is a rational number from 2 to 4;
x is a rational number from 1 to 3;
y is a rational number from 10 to 14; and
z is a rational number from 0 to 1;
b is a rational number from 0 to 1;
wherein z+b≤1; and
u, v, x, y, and z are selected so that the lithium-stuffed garnet oxide is charge neutral.

34. The composition of claim 16, wherein the oxide is Li_{6.4}Ga_{0.2}La₃Zr₂O₁₂.

35. The composition of any one of claims 1-34, wherein the total effective lithium ion conductivity is greater than 10⁻³ S/cm at 45° C.

36. The composition of any one of claims 1-34, wherein the lithium interfacial area-specific resistance is less than 20 Ωcm² at 45° C.

37. A composition comprising a lithium-stuffed garnet and a composition of any one of claims 1-36, wherein the composition of any one of claims 1-36 coats the surface of the lithium-stuffed garnet.

38. A composition comprising a lithium-stuffed garnet and a composition of any one of claims 1-36, wherein the composition of any one of claims 1-36 is conformally bonded to the surface of the lithium-stuffed garnet.

39. A composition comprising a lithium-stuffed garnet and a composition of any one of claims 1-36, wherein the composition of any one of claims 1-36 is bonded to defects in the lithium-stuffed garnet.

40. The composition of any one of claims 1-10 and 14-39, wherein the composition is a thin film and wherein the thin film has a thickness greater than 10 nm and less than 30 μm.

41. The composition of claim 40, wherein the thickness is less than 20 μm.

42. The composition of claim 40, wherein the thickness is less than 10 μm.

43. The composition of claim 40, wherein the thickness is less than 5 μm.

44. The composition of claim 40, wherein the thickness is less than 1 μm.

45. The composition of any one of claims 1-10 and 14-39, wherein the composition is a thin film and wherein the thin film has a porosity less than 5 percent.

46. The composition of claim 45, wherein the porosity is less than 4 percent.

47. The composition of claim 45, wherein the porosity is less than 3 percent.

48. The composition of claim 45, wherein the porosity is less than 2 percent.

49. The composition of claim 45, wherein the porosity is less than 1 percent.

50. The composition of claim 45, wherein the porosity is less than 0.5 percent.

51. An electrochemical cell comprising a composition of any one of claims 1-50.

52. The electrochemical cell of claim 51, wherein the electrochemical cell is a rechargeable battery.

53. An electrochemical cell comprising:
a lithium metal negative electrode;
a solid separator; and
a positive electrode,
wherein the solid separator is between and in direct contact with the lithium metal negative electrode and the positive electrode; and
wherein the solid separator is a composition of any one of claims 1-50.

54. The electrochemical cell of claim 53, wherein the solid separator is less than 20 μm thick.

55. A method for making a thin film comprising A.(LiBH₄)1−A.(P₂S₅), wherein 0.05≤A≤0.95, comprising:
(a) providing a powder mixture, wherein the powder mixture comprises: A(LiBH₄)(1−A)(P₂S₅), wherein 0.05≤A≤0.95;
(b) Milling the powder mixture;
(c) mixing the powder mixture with a solvent or a binder or both a solvent and a binder;
(d) casting or coating the powder mixture on a substrate;
(e) spinning the substrate at 3000 rpm to form a thin film;
(0 evaporating the solvent, if present;
(g) placing the film and the substrate under pressure.

56. The method of claim 55, further comprising heating the film and the substrate.

57. The method of claim 56, wherein the heating is to at least 300° C.

58. The method of claim 56, wherein the heating is to at least 500° C.

59. The method of claim 56, wherein the heating is to at least 7300° C.

60. The method of claim 56, wherein the heating is to at least 1000° C.

61. The method of claim 56, wherein the heating is to at maximum of 1500° C.

62. The method of any one of claims 54-61, wherein the solvent is selected from the group consisting of toluene, hexane, and tert-butyl amine.

63. The method of claim 54, wherein the binder is an ethylene alpha-olefin copolymer.

64. An electrochemical device comprising of:
a lithium metal negative electrode;
a solid-state electrolyte;
a solid-state positive electrode; and
a composition of claim 1-50 or a thin film made by the method of claims 54-63;
wherein:
the solid-state electrolyte is between and in contact with the lithium metal negative electrode and the solid-state positive electrode; and
the composition of claim 1-50 or the thin film made by the method of claims 54-63 is between and in contact with the solid-state electrolyte and the solid-state positive electrode.

65. The electrochemical device of claim 64, where the solid-state positive electrode comprises active material selected from the group consisting of NCA, LNMO, and NMC.

66. The electrochemical device of claim 64 or 65, where the solid-state positive electrode comprises a sulfide catholyte.

67. The electrochemical device of claim 66, where the sulfide catholyte is LSTPS LSPSCl.

68. The electrochemical device of any one of claims 64-67, wherein the solid-state positive electrode further comprises a binder.

69. The electrochemical device of any one of claims 64-68, wherein the solid-state positive electrode further comprises a conductive additive.

70. The electrochemical device of any one of claims 64-69, wherein the solid-state electrolyte is a thin film.

71. The electrochemical device of claim 70, wherein the thin film has a thickness of about 1-200 μm.

72. The electrochemical device of any one of claims 64-69, wherein the solid-state electrolyte is a monolith.

73. The electrochemical device of any one of claims 64-69, wherein the solid-state electrolyte is a pressed pellet.

74. The electrochemical device of claim 73, wherein the solid-state electrolyte is 1 mm-100 mm in length.

75. The electrochemical device of any one of claims 64-74, wherein the solid-state electrolyte has porosity of <5%.

76. The electrochemical device of claim 75, wherein the porosity is less than 0.5%.

77. The electrochemical device of any one of claims 64-74, wherein the solid-state electrolyte is a lithium-stuffed garnet oxide characterized by the formula LiᵤLaᵥZrₓO_{y}.zAl₂O₃, wherein
u is a rational number from 4 to 8;
v is a rational number from 2 to 4;
x is a rational number from 1 to 3;
y is a rational number from 10 to 14; and
z is a rational number from 0.05 to 1;
wherein u, v, x, y, and z are selected so that the lithium-stuffed garnet oxide is charge neutral.

78. A method for making a multilayer component comprising the composition of claim 1, comprising:
(a) providing a first composition, wherein the composition comprises: A(LiBH₄)(1−A)(P₂S₅), wherein 0.05≤A≤0.95;
(b) dropping or spraying a powder of the first composition on a substrate;
(c) heating the powder on the substrate to above the powder melting point but below than the powder mixture decomposition temperature;
(e) providing a layer of a second composition on top of the powder on a substrate to form a multilayer;
(f) applying 1 pounds-per-square inch (PSI) to 1000 PSI pressure to the multilayer; and
(f) cooling the powder on a substrate to room temperature.

79. The method of claim 78, further comprising spinning the substrate at high speed, for example 100 to 5000 rpm.

80. The method of claim 79, further comprising spinning the substrate at high speed, for example 100 to 5000 rpm before cooling the powder mixture on a substrate to room temperature.

81. The method of any one of claims 78-80, wherein the second composition is an electrolyte.

82. The method of any one of claims 78-80, wherein the second composition is a lithium-stuffed garnet.

83. The method of any one of claim 55-63 or 78-82, wherein the substrate is a metal selected from the group consisting of copper and nickel.

84. The method of any one of claim 55-63 or 78-82, wherein the substrate is a foil.

85. The method of any one of claim 55-63 or 78-82, wherein the substrate is LPSI.

86. The method of any one of claim 55-63 or 78-82, wherein the substrate is LPSI composite.

87. The method of any one of claim 55-63 or 78-82, wherein the substrate is LSTPS.

88. The method of any one of claim 55-63 or 78-82, wherein the substrate is LSTPS composite.

89. The method of any one of claim 55-63 or 78-82, wherein the substrate is solid state positive electrode comprising:
an active material selected from NCA or NMC;
a sulfide catholyte;
carbon; and
binder.

90. A composite comprising a lithium-stuffed garnet and a composition of any one of claims 1-50,
wherein the composition of any one of claims 1-59 infiltrates at least 90% of the through-pores or surface pores of the lithium-stuffed garnet.

91. A composite comprising a lithium-stuffed garnet and composition of any one of claims 1-50,
wherein the composition of any one of claims 1-50 fills at least 90% of the through-pores or surface pores of the lithium-stuffed garnet.

92. A composition comprising a roughened lithium-stuffed garnet having a coating of a composition of any one of claims 1-50 on the lithium-stuffed garnet.

93. A composition comprising a curved lithium-stuffed garnet having a coating of a composition of any one of claims 1-50 on the lithium-stuffed garnet.

94. A composition comprising a corrugated lithium-stuffed garnet having a coating of a composition of any one of claims 1-50 on the lithium-stuffed garnet.

95. A composition comprising a lithium-stuffed garnet and a composition of any one of claims 1-50 interdigitated within the lithium-stuffed garnet.

96. A method for coating a lithium-ion conducting separator electrolyte, the method comprising:
a) providing the lithium-ion conducting separator electrolyte; and
b) pressing a composition of A(LiBH₄)(1−A)(P₂S₅) on to at least one surface of the lithium-ion conducting separator electrolyte;
wherein the pressing is at a temperature between 100-280° C. and at a pressure of 10-2000 PSI.

97. The method of claim 96, wherein the temperature is below the melting point (Tₘ) of the separator.

98. The method of claim 96, wherein the temperature is about 0.8Tₘ Kelvin (K).

99. The method of any one of claims 96-98, further comprising c) pressing for 1-300 minutes (min).

100. The method of any one of claims 96-98, further comprising d) cooling while pressing for 10-1000 min.

101. The method of claim 100, wherein the cooling is to room temperature.

102. A method for coating a lithium-ion conducting electrolyte separator, the method comprising:
a) providing a lithium-ion conducting electrolyte separator;
b) providing a mixture of a solvent and a composition of any one of claims 1-50; and
c) depositing the mixture on the separator by spray coating, melt spin coating, spin coating, dip coating, slot die coating, gravure coating, or microgravure coating.

103. The method of claim 102, wherein the solvent is selected from the group consisting of tetrahydrofuran, diethyl ether, pyridine, methanol, and ethanol.

104. The method of claim 103, wherein the solvent is selected from the group consisting of tetrahydrofuran, diethyl ether, methanol and ethanol.

105. The method of any one of claims 102-104, wherein the lithium-ion conducting electrolyte separator has defects on the surface.

106. The method of claim 102, wherein prior to step (a) the method comprises preparing a composition of any one of claims 1-50.

107. The composition of claim 1, wherein A>0.5

108. The composition of claim 1, wherein A>0.75
